(19) United States
(12) Patent Application Publication
(10) Pub. No.: US 2020/0075008 A1
(43) Pub. Date: Mar. 5, 2020

(54) VOICE DATA PROCESSING METHOD AND ELECTRONIC DEVICE FOR SUPPORTING SAME

(71) Applicant: SAMSUNG ELECTRONICS CO., LTD., Suwon-si, Gyeonggi-do (KR)

(72) Inventors: Jae Wook KIM, Suwon-si, Gyeonggi-do (KR); Ga Jin SONG, Anyang-si, Gyeonggi-do (KR)

(21) Appl. No.: 16/605,641

(22) PCT Filed: Mar. 14, 2018
(86) PCT No.: PCT/KR2018/002993

§ 371 Date: Oct. 16, 2019

(30) Foreign Application Priority Data
Apr. 17, 2017 (KR) 10-2017-0049411
Apr. 28, 2017 (KR) 10-2017-0054913

(51) Int. Cl. G10L 15/22; G10L 15/30; G06F 3/16; G10L 15/26; G06F 3/0481; G06F 3/0488

(52) U.S. Cl. CPC G10L 15/22; G10L 15/30; G06F 3/167; G10L 2015/223; G06F 3/0481; G06F 3/04883; G10L 15/265

(57) ABSTRACT

Disclosed is an electronic device comprising a microphone, a communication circuit, a display, a memory for storing at least one application, and a processor, wherein the processor is configured to: acquire voice data corresponding to a user's voice received through the microphone; acquire first information on at least one text displayed on the screen of the display; transmit the voice data to an external electronic device through the communication circuit; receive, from the external electronic device through the communication circuit, first text data converted on the basis of the voice data; determine whether second text data, which is same as the first text data, exists in the first information; perform a first function corresponding to the second text data by using the first information, if the second text data exists; receive, from the external electronic device through the communication circuit, second information configured such that a second function of the at least one application is performed; perform the second function if the first function is not performed; and limit processing of the second information if the first function is performed. In addition, other examples identified through the specification are possible.

### TECHNICAL FIELD

Various embodiments disclosed in this specification relate to a technology for voice data processing. In particular, voice data processing in an artificial intelligence (AI) system utilizing a machine learning algorithm and an application thereof.

### BACKGROUND ART

An AI system (or integrated intelligence system) is a computer system implementing human intelligence and refers to a system that learns and judges by itself and improves a recognition rate as it is used.

The AI technology includes a machine learning (deep learning) technology using an algorithm that classifies or learns the characteristics of pieces of input data by the AI system, and element technologies that simulate the functions of the human brain, for example, recognition, determination, and the like, using a machine learning algorithm.

For example, the element technologies may include at least one of a linguistic understanding technology that recognizes the language/character of a human, a visual understanding technology that recognizes objects like human vision, an inference/prediction technology that determines information to logically infer and predict the determined information, a knowledge expression technology that processes human experience information as knowledge data, and an operation control technology that controls autonomous driving of the vehicle and the motion of the robot.

The linguistic understanding technology among the above-described element technologies includes natural language processing, machine translation, dialogue system, query response, speech recognition/synthesis, and the like as a technology to recognize and apply/process human language/characters.

In the meantime, when a specified hardware key is pressed or when a specified voice is entered via a microphone, an electronic device equipped with the AI system may launch an intelligence app such as a speech recognition app (or application) and may enter a waiting state for receiving a user's voice input via the intelligence app. For example, the electronic device may display the user interface (UI) of the intelligence app on the screen of a display; when a voice input button in the UI is touched, the electronic device may receive the voice input of the user.

Furthermore, the electronic device may transmit voice data corresponding to the received voice input to an intelligence server. In this case, the intelligence server may convert the received voice data into text data and may determine a path rule including information about an action for performing the function of at least one application included in the electronic device or information about a parameter necessary to perform the action, based on the converted text data. Afterwards, the electronic device may receive the path rule from the intelligence server to perform the action depending on the path rule.

### DISCLOSURE

### Technical Problem

Even when a user simply utters the voice corresponding to a text displayed on a screen, an electronic device that receives the path rule from an intelligence server and then processes the received path rule needs to go through a series of steps until receiving the path rule from the intelligence server. That is, even when the user simply desires to allow a specified function to be performed via a user input interface (e.g., a button object, an icon, or the like) displayed on the screen, the electronic device needs to wait until the intelligence server determines the path rule and then transmits the path rule to the electronic device.

Embodiments disclosed in this specification, a voice data processing method that may obtain text data obtained by converting voice data from the intelligence server and then may perform a specified function based on the text data, and an electronic device supporting the same.

### Technical Solution

According to an embodiment disclosed in this specification, an electronic device may include a microphone, a communication circuit, a display, a memory storing at least one application and a processor electrically connected to the microphone, the communication circuit, the display, and the memory. The processor may be configured to obtain voice data corresponding to a voice of a user received via the microphone to obtain first information about at least one text displayed on a screen of the display, to transmit the voice data to an external electronic device via the communication circuit to receive first text data converted based on the voice data from the external electronic device via the communication circuit, to determine whether second text data the same as the first text data is present in the first information, to execute a first function corresponding to the second text data, using the first information when the second text data is present, to receive second information configured to execute a second function of the at least one application, from the external electronic device via the communication circuit, and to execute the second function when the first function is not executed and restrict processing of the second information when the first function is executed.

Moreover, according to an embodiment disclosed in this specification, an electronic device may include a microphone, a communication circuit, a display, a memory storing at least one application, and a processor electrically connected to the microphone, the communication circuit, the display, and the memory. The processor may be configured to obtain voice data corresponding to a voice of a user received via the microphone to obtain first information about at least one text displayed on a screen of the display, to transmit the voice data to an external electronic device via the communication circuit to receive first text data converted based on the voice data from the external electronic device via the communication circuit, to determine whether second text data the same as the first text data is present in the first information, to execute a first function corresponding to the second text data, using the first information when the second text data is present, and to enter a waiting state for receiving second information configured to execute a second function of the at least one application when the second text data is not present.

Furthermore, according to an embodiment disclosed in this specification, a voice data processing method of an electronic device may include obtaining voice data corresponding to a voice of a user received via a microphone, obtaining first information about at least one text displayed on a screen of a display, transmitting the voice data to an external electronic device via a communication circuit, receiving first text data converted based on the voice data, from the external electronic device via the communication circuit, determining whether second text data the same as the first text data is present in the first information, executing a first function corresponding to the second text data, using the first information when the second text data is present, receiving second information configured to execute a second function of at least one application stored in a memory, from the external electronic device via the communication circuit, determining whether the first function is executed, executing the second function when the first function is not executed, and restricting processing of the second information when the first function is executed.

### Advantageous Effects

According to embodiments disclosed in this specification, the function may be performed without a series of steps processed by an intelligence server.

Besides, a variety of effects directly or indirectly understood through the disclosure may be provided.

### DESCRIPTION OF DRAWINGS

FIG. 1 is a view illustrating an integrated intelligence system, according to various embodiments of the disclosure.

FIG. 2 is a block diagram illustrating a user terminal of an integrated intelligence system, according to an embodiment of the disclosure.

FIG. 3 is a view illustrating that an intelligence app of a user terminal is executed, according to an embodiment of the disclosure.

FIG. 4 is a block diagram illustrating an intelligence server of an integrated intelligence system, according to an embodiment of the disclosure.

FIG. 5 is a view illustrating a path rule generating method of a natural language understanding (NLU) module, according to an embodiment of the disclosure.

FIG. 6 is a block diagram of an electronic device associated with voice data processing, according to an embodiment of the disclosure.

FIG. 7A is a flowchart illustrating an operating method of an electronic device associated with voice data processing, according to an embodiment of the disclosure.

FIG. 7B is a flowchart illustrating another operating method of an electronic device associated with voice data processing, according to another embodiment of the disclosure.

FIG. 8 is a block diagram illustrating an operating method of a system associated with voice data processing, according to an embodiment of the disclosure.

FIG. 9 is a view illustrating another operating method of an electronic device associated with voice data processing, according to an embodiment of the disclosure.

FIG. 10 is a view illustrating another operating method of a system associated with voice data processing, according to an embodiment of the disclosure.

FIG. 11 is a block diagram of a system associated with voice data processing, according to an embodiment of the disclosure.

FIG. 12 is a view for describing screen configuration information, according to an embodiment of the disclosure.

FIG. 13 is a view for describing function execution using screen configuration information, according to an embodiment of the disclosure.

FIG. 14 is a view for describing function execution using a part of screen configuration information, according to an embodiment of the disclosure.

FIG. 15 illustrates a block diagram of an electronic device in a network environment according to various embodiments.

With regard to description of drawings, similar components may be marked by similar reference numerals.

### MODE FOR INVENTION

Hereinafter, various embodiments of the disclosure may be described to be associated with accompanying drawings. Accordingly, those of ordinary skill in the art will recognize that modification, equivalent, and/or alternative on the various embodiments described herein can be variously made without departing from the scope and spirit of the disclosure.

Before describing an embodiment of the disclosure, an integrated intelligence system to which an embodiment of the disclosure is applied will be described.

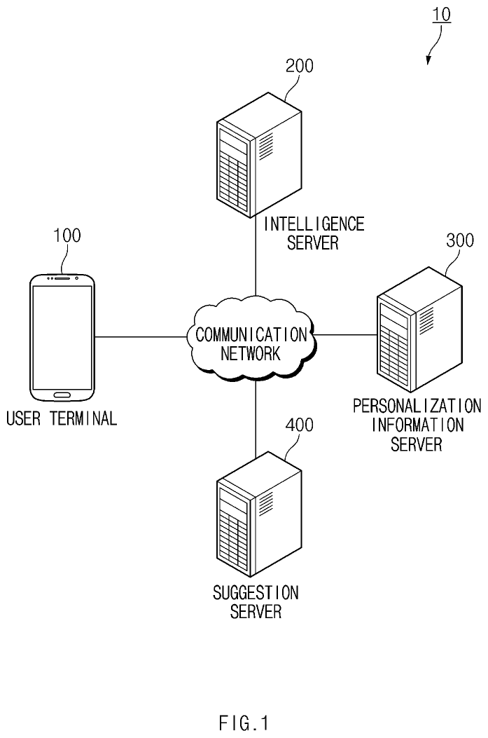

FIG. 1 is a view illustrating an integrated intelligence system, according to various embodiments of the disclosure.

Referring to FIG. 1, an integrated intelligence system 10 may include a user terminal 100, an intelligence server 200, a personalization information server 300, or a suggestion server 400.

The user terminal 100 may provide a service necessary for a user through an app (or an application program) (e.g., an alarm app, a message app, a picture (gallery) app, or the like) stored in the user terminal 100. For example, the user terminal 100 may execute and operate other app through an intelligence app (or a speech recognition app) stored in the user terminal 100. A user input for launching and operating the other app through the intelligence app of the user terminal 100 may be received. For example, the user input may be received through a physical button, a touch pad, a voice input, a remote input, or the like. According to an embodiment, various types of terminal devices (or an electronic device), which are connected with Internet, such as a mobile phone, a smartphone, personal digital assistant (PDA), a notebook computer, and the like may correspond to the user terminal 100.

According to an embodiment, the user terminal 100 may receive user utterance as a user input. The user terminal 100 may receive the user utterance and may generate an instruction for operating an app based on the user utterance. As such, the user terminal 100 may operate the app by using the instruction.

The intelligence server 200 may receive a voice input of a user from the user terminal 100 over a communication network and may change the voice input to text data. In another embodiment, the intelligence server 200 may generate (or select) a path rule based on the text data. The path rule may include information about an action (or an operation or a task) for performing the function of an app or information about a parameter necessary to perform the action. In addition, the path rule may include the order of the action of the app. The user terminal 100 may receive the path rule, may select an app depending on the path rule, and may execute an action included in the path rule in the selected app.

For example, the user terminal 100 may execute the action and may display a screen corresponding to a state of the user terminal 100, which executes the action, in a display. For another example, the user terminal 100 may execute the action and may not display the result obtained by executing the action in the display. For example, the user terminal 100 may execute a plurality of actions and may display only the result of a part of the plurality of actions in the display. For example, the user terminal 100 may display only the result, which is obtained by executing the last action, in the display. For another example, the user terminal 100 may receive the user input to display the result obtained by executing the action in the display.

The personalization information server 300 may include a database in which user information is stored. For example, the personalization information server 300 may receive the user information (e.g., context information, information about execution of an app, or the like) from the user terminal 100 and may store the user information in the database. The intelligence server 200 may receive the user information from the personalization information server 300 over the communication network and may use the user information when generating a path rule associated with the user input. According to an embodiment, the user terminal 100 may receive the user information from the personalization information server 300 over the communication network, and may use the user information as information for managing the database.

The suggestion server 400 may include a database storing information about a function in a terminal, introduction of an application, or a function to be provided. For example, the suggestion server 400 may receive the user information of the user terminal 100 from the personalization information server 300 and may include a database including information about a function capable of being utilized by a user. The user terminal 100 may receive information about the function to be provided from the suggestion server 400 over the communication network and may provide the received information to the user.

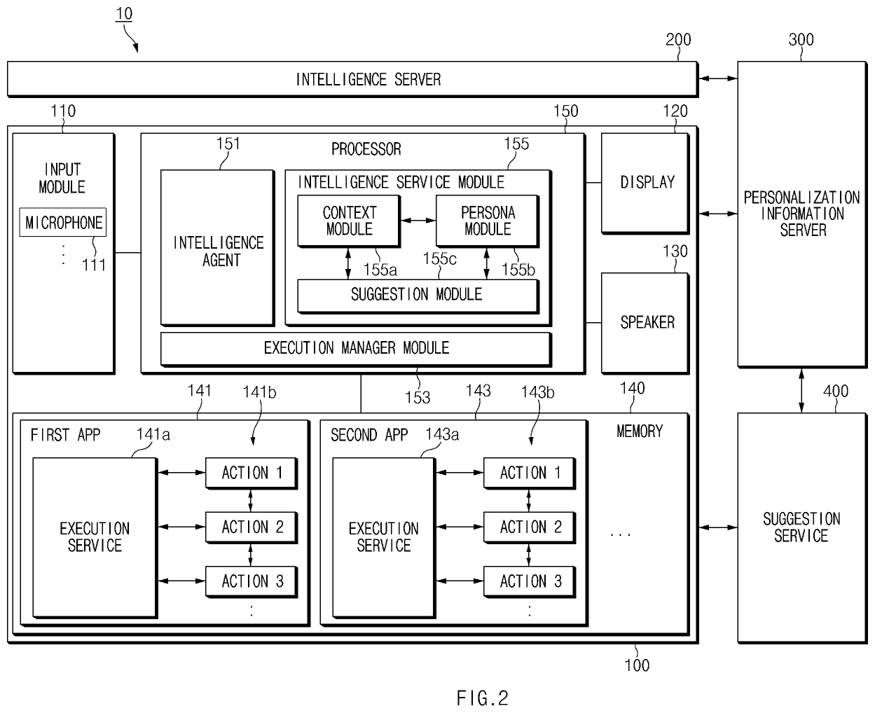

FIG. 2 is a block diagram illustrating a user terminal of an integrated intelligence system, according to an embodiment of the disclosure.

Referring to FIG. 2, the user terminal 100 may include an input module 110, a display 120, a speaker 130, a memory 140, or a processor 150. The user terminal 100 may further include housing, and elements of the user terminal 100 may be seated in the housing or may be positioned on the housing.

According to an embodiment, the input module 110 may receive a user input from a user. For example, the input module 110 may receive the user input from the connected external device (e.g., a keyboard or a headset). For another example, the input module 110 may include a touch screen (e.g., a touch screen display) coupled to the display 120. For another example, the input module 110 may include a hardware key (or a physical key) placed in the user terminal 100 (or the housing of the user terminal 100).

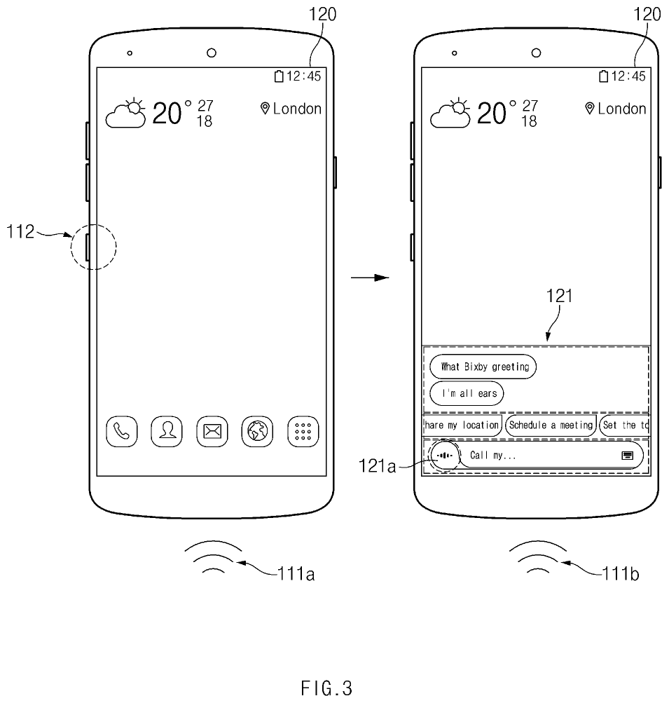

According to an embodiment, the input module 110 may include a microphone (e.g., a microphone 111 of FIG. 3) that is capable of receiving user utterance as a voice signal. For example, the input module 110 may include a speech input system and may receive the utterance of the user as a voice signal through the speech input system.

According to an embodiment, the display 120 may display an image, a video, and/or an execution screen of an application. For example, the display 120 may display a graphic user interface (GUI) of an app.

According to an embodiment, the speaker 130 may output the voice signal. For example, the speaker 130 may output the voice signal generated in the user terminal 100 to the outside.

According to an embodiment, the memory 140 may store a plurality of apps 141 and 143. The plurality of apps 141 and 143 stored in the memory 140 may be selected, launched, and executed depending on the user input.

According to an embodiment, the memory 140 may include a database capable of storing information necessary to recognize the user input. For example, the memory 140 may include a log database capable of storing log information. For another example, the memory 140 may include a persona database capable of storing user information.

According to an embodiment, the memory 140 may store the plurality of apps 141 and 143, and the plurality of apps 141 and 143 may be loaded to operate. For example, the plurality of apps 141 and 143 stored in the memory 140 may be loaded by an execution manager module 153 of the processor 150 to operate. The plurality of apps 141 and 143 may include execution services 141a and 143a performing a function or a plurality of actions (or unit actions) 141b and 143b. The execution services 141a and 143a may be generated by the execution manager module 153 of the processor 150 and then may execute the plurality of actions 141b and 143b.

According to an embodiment, when the actions 141b and 143b of the apps 141 and 143 are executed, an execution state screen according to the execution of the actions 141b and 143b may be displayed in the display 120. For example, the execution state screen may be a screen in a state where the actions 141b and 143b are completed. For another example, the execution state screen may be a screen in a state where the execution of the actions 141b and 143b is in partial landing (e.g., when a parameter necessary for the actions 141b and 143b are not input).

According to an embodiment, the execution services 141a and 143a may execute the actions 141b and 143b depending on a path rule. For example, the execution services 141a and 143a may be generated by the execution manager module 153, may receive an execution request from the execution manager module 153 depending on the path rule, and may execute the actions of the apps 141 and 143 by executing actions 141b and 143b depending on the execution request. When the execution of the actions 141b and 143b is completed, the execution services 141a and 143a may transmit completion information to the execution manager module 153.

According to an embodiment, when the plurality of the actions 141b and 143b are respectively executed in the apps 141 and 143, the plurality of the actions 141b and 143b may be sequentially executed. When the execution of one action (action 1) is completed, the execution services 141a and 143a may open the next action (action 2) and may transmit completion information to the execution manager module 153. Here, it is understood that opening an arbitrary action is to change a state of the arbitrary action to an executable state or to prepare the execution of the arbitrary action. In other words, when the arbitrary action is not opened, the corresponding action may be not executed. When the completion information is received, the execution manager module 153 may transmit an execution request for the next actions 141b and 143b to an execution service (e.g., action 2). According to an embodiment, when the plurality of apps 141 and 143 are executed, the plurality of apps 141 and 143 may be sequentially executed. For example, when receiving the completion information after the execution of the last action of the first app 141 is executed, the execution manager module 153 may transmit the execution request of the first action of the second app 143 to the execution service 143a.

According to an embodiment, when the plurality of the actions 141b and 143b are executed in the apps 141 and 143, a result screen according to the execution of each of the executed plurality of the actions 141b and 143b may be displayed in the display 120. According to an embodiment, only a part of a plurality of result screens according to the executed plurality of the actions 141b and 143b may be displayed in the display 120.

According to an embodiment, the memory 140 may store an intelligence app (e.g., a speech recognition app) operating in conjunction with an intelligence agent 151. The app operating in conjunction with the intelligence agent 151 may receive and process the utterance of the user as a voice signal. According to an embodiment, the app operating in conjunction with the intelligence agent 151 may be operated by a specific input (e.g., an input through a hardware key, an input through a touch screen, or a specific voice input) input through the input module 110.

According to an embodiment, the processor 150 may control overall actions of the user terminal 100. For example, the processor 150 may control the input module 110 to receive the user input. The processor 150 may control the display 120 to display an image. The processor 150 may control the speaker 130 to output the voice signal. The processor 150 may control the memory 140 to read or store necessary information.

According to an embodiment, the processor 150 may include the intelligence agent 151, the execution manager module 153, or an intelligence service module 155. In an embodiment, the processor 150 may drive the intelligence agent 151, the execution manager module 153, or the intelligence service module 155 by executing instructions stored in the memory 140. Modules described in various embodiments of the disclosure may be implemented by hardware or by software. In various embodiments of the disclosure, it is understood that the action executed by the intelligence agent 151, the execution manager module 153, or the intelligence service module 155 is an action executed by the processor 150.

According to an embodiment, the intelligence agent 151 may generate an instruction for operating an app based on the voice signal received as the user input. According to an embodiment, the execution manager module 153 may receive the generated instruction from the intelligence agent 151, and may select, launch, and operate the apps 141 and 143 stored in the memory 140 depending on the generated instruction. According to an embodiment, the intelligence service module 155 may manage information of the user and may use the information of the user to process the user input.

The intelligence agent 151 may transmit the user input received through the input module 110 to the intelligence server 200.

According to an embodiment, before transmitting the user input to the intelligence server 200, the intelligence agent 151 may pre-process the user input. According to an embodiment, to pre-process the user input, the intelligence agent 151 may include an adaptive echo canceller (AEC) module, a noise suppression (NS) module, an end-point detection (EPD) module, or an automatic gain control (AGC) module. The AEC may remove an echo included in the user input. The NS module may suppress a background noise included in the user input. The EPD module may detect an end-point of a user voice included in the user input to search for a part in which the user voice is present. The AGC module may adjust the volume of the user input so as to be suitable to recognize and process the user input. According to an embodiment, the intelligence agent 151 may include all the pre-processing elements for performance. However, in another embodiment, the intelligence agent 151 may include a part of the pre-processing elements to operate at low power.

According to an embodiment, the intelligence agent 151 may include a wake up recognition module recognizing a call of a user. The wake up recognition module may recognize a wake up instruction of the user through the speech recognition module. When the wake up recognition module receives the wake up instruction, the wake up recognition module may activate the intelligence agent 151 to receive the user input. According to an embodiment, the wake up recognition module of the intelligence agent 151 may be implemented with a low-power processor (e.g., a processor included in an audio codec). According to an embodiment, the intelligence agent 151 may be activated depending on the user input entered through a hardware key. When the intelligence agent 151 is activated, an intelligence app (e.g., a speech recognition app) operating in conjunction with the intelligence agent 151 may be executed.

According to an embodiment, the intelligence agent 151 may include a speech recognition module for performing the user input. The speech recognition module may recognize the user input for executing an action in an app. For example, the speech recognition module may recognize a limited user (voice) input (e.g., utterance such as “click” for executing a capturing action when a camera app is being executed) for executing an action such as the wake up instruction in the apps 141 and 143. For example, the speech recognition module for recognizing a user input while assisting the intelligence server 200 may recognize and rapidly process a user instruction capable of being processed in the user terminal 100. According to an embodiment, the speech recognition module for executing the user input of the intelligence agent 151 may be implemented in an app processor.

According to an embodiment, the speech recognition module (including the speech recognition module of a wake up module) of the intelligence agent 151 may recognize the user input by using an algorithm for recognizing a voice. For example, the algorithm for recognizing the voice may be at least one of a hidden Markov model (HMM) algorithm, an artificial neural network (ANN) algorithm, or a dynamic time warping (DTW) algorithm.

According to an embodiment, the intelligence agent 151 may change the voice input of the user to text data. According to an embodiment, the intelligence agent 151 may deliver the voice of the user to the intelligence server 200 to receive the changed text data. As such, the intelligence agent 151 may display the text data in the display 120.

According to an embodiment, the intelligence agent 151 may receive a path rule from the intelligence server 200. According to an embodiment, the intelligence agent 151 may transmit the path rule to the execution manager module 153.

According to an embodiment, the intelligence agent 151 may transmit the execution result log according to the path rule received from the intelligence server 200 to the intelligence service module 155, and the transmitted execution result log may be accumulated and managed in preference information of the user of a persona module 155b.

According to an embodiment, the execution manager module 153 may receive the path rule from the intelligence agent 151 to execute the apps 141 and 143 and may allow the apps 141 and 143 to execute the actions 141b and 143b included in the path rule. For example, the execution manager module 153 may transmit instruction information for executing the actions 141b and 143b to the apps 141 and 143 and may receive completion information of the actions 141b and 143b from the apps 141 and 143.

According to an embodiment, the execution manager module 153 may transmit or receive the instruction information for executing the actions 141b and 143b of the apps 141 and 143 between the intelligence agent 151 and the apps 141 and 143. The execution manager module 153 may bind the apps 141 and 143 to be executed depending on the path rule and may transmit the instruction information of the actions 141b and 143b included in the path rule to the apps 141 and 143. For example, the execution manager module 153 may sequentially transmit the actions 141b and 143b included in the path rule to the apps 141 and 143 and may sequentially execute the actions 141b and 143b of the apps 141 and 143 depending on the path rule.

According to an embodiment, the execution manager module 153 may manage execution states of the actions 141b and 143b of the apps 141 and 143. For example, the execution manager module 153 may receive information about the execution states of the actions 141b and 143b from the apps 141 and 143. For example, when the execution states of the actions 141b and 143b are in partial landing (e.g., when a parameter necessary for the actions 141b and 143b are not input), the execution manager module 153 may transmit information about the partial landing to the intelligence agent 151. The intelligence agent 151 may make a request for an input of necessary information (e.g., parameter information) to the user by using the received information. For another example, when the execution state of the actions 141b and 143b are in an operating state, the utterance may be received from the user, and the execution manager module 153 may transmit information about the apps 141 and 143 being executed and the execution states of the apps 141 and 143 to the intelligence agent 151. The intelligence agent 151 may receive parameter information of the utterance of the user through the intelligence server 200 and may transmit the received parameter information to the execution manager module 153. The execution manager module 153 may change a parameter of each of the actions 141b and 143b to a new parameter by using the received parameter information.

According to an embodiment, the execution manager module 153 may deliver the parameter information included in the path rule to the apps 141 and 143. When the plurality of apps 141 and 143 are sequentially executed depending on the path rule, the execution manager module 153 may deliver the parameter information included in the path rule from one app to another app.

According to an embodiment, the execution manager module 153 may receive a plurality of path rules. The execution manager module 153 may select a plurality of path rules based on the utterance of the user. For example, when the user utterance specifies the app 141 executing a part of the action 141b but does not specify the app 143 executing any other action 143b, the execution manager module 153 may receive a plurality of different path rules in which the same app 141 (e.g., an gallery app) executing the part of the action 141b is executed and in which different apps 143 (e.g., a message app or a Telegram app) executing the other action 143b. For example, the execution manager module 153 may execute the same actions 141b and 143b (e.g., the same successive actions 141b and 143b) of the plurality of path rules. When the execution manager module 153 executes the same action, the execution manager module 153 may display a state screen for selecting the different apps 141 and 143 included in the plurality of path rules in the display 120.

According to an embodiment, the intelligence service module 155 may include a context module 155a, a persona module 155b, or a suggestion module 155c.

The context module 155a may collect current states of the apps 141 and 143 from the apps 141 and 143. For example, the context module 155a may receive context information indicating the current states of the apps 141 and 143 to collect the current states of the apps 141 and 143.

The persona module 155b may manage personal information of the user utilizing the user terminal 100. For example, the persona module 155b may collect the usage information and the execution result of the user terminal 100 to manage personal information of the user.

The suggestion module 155c may predict the intent of the user to recommend an instruction to the user. For example, the suggestion module 155c may recommend an instruction to the user in consideration of the current state (e.g., a time, a place, context, or an app) of the user.

FIG. 3 is view illustrating that an intelligence app of a user terminal is executed, according to an embodiment of the disclosure.

FIG. 3 illustrates that the user terminal 100 receives a user input to execute an intelligence app (e.g., a speech recognition app) operating in conjunction with the intelligence agent 151.

According to an embodiment, the user terminal 100 may execute the intelligence app for recognizing a voice through a hardware key 112. For example, when the user terminal 100 receives the user input through the hardware key 112, the user terminal 100 may display a UI 121 of the intelligence app in the display 120. For example, a user may touch a speech recognition button 121a of the UI 121 of the intelligence app for the purpose of entering a voice 111b in a state where the UI 121 of the intelligence app is displayed in the display 120. For another example, while continuously pressing the hardware key 112 to enter the voice 111b, the user may enter the voice 111b.

According to an embodiment, the user terminal 100 may execute the intelligence app for recognizing a voice through the microphone 111. For example, when a specified voice (e.g., wake up!) is entered 111a through the microphone 111, the user terminal 100 may display the UI 121 of the intelligence app in the display 120.

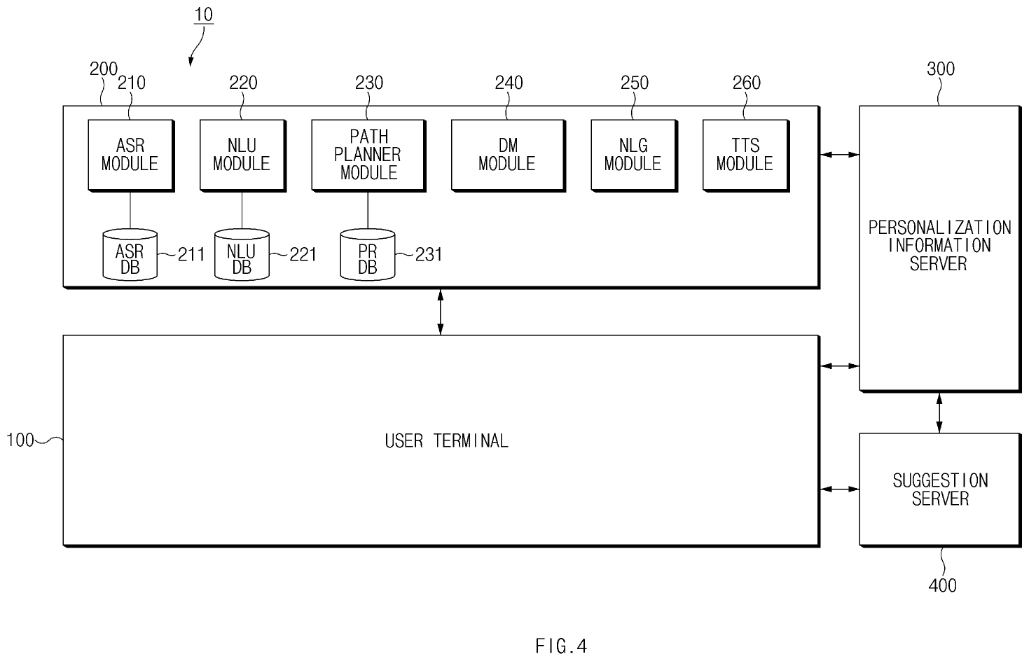

FIG. 4 is a block diagram illustrating an intelligence server of an integrated intelligence system, according to an embodiment of the disclosure.

Referring to FIG. 4, the intelligence server 200 may include an automatic speech recognition (ASR) module 210, a natural language understanding (NLU) module 220, a path planner module 230, a dialogue manager (DM) module 240, a natural language generator (NLG) module 250, or a text to speech (TTS) module 260.

The NLU module 220 or the path planner module 230 of the intelligence server 200 may generate a path rule.

According to an embodiment, the ASR module 210 may convert the user input received from the user terminal 100 into text data. For example, the ASR module 210 may include an utterance recognition module. The utterance recognition module may include an acoustic model and a language model. For example, the acoustic model may include information associated with utterance, and the language model may include unit phoneme information and information about a combination of unit phoneme information. The utterance recognition module may change user utterance to text data by using the information associated with utterance and unit phoneme information. For example, the information about the acoustic model and the language model may be stored in an automatic speech recognition database (ASR DB) 211.

According to an embodiment, the NLU module 220 may grasp user intent by performing syntactic analysis or semantic analysis. The syntactic analysis may divide the user input into syntactic units (e.g., words, phrases, morphemes, and the like) and determine which syntactic elements the divided units have. The semantic analysis may be performed by using semantic matching, rule matching, formula matching, or the like. As such, the NLU module 220 may obtain a domain associated with the user input, intent, or a parameter (or a slot) necessary to express the intent.

According to an embodiment, the NLU module 220 may determine the intent of the user and parameter by using a matching rule that is divided into a domain, intent, and a parameter (or a slot) necessary to grasp the intent. For example, the one domain (e.g., an alarm) may include a plurality of intent (e.g., alarm settings, alarm cancellation, and the like), and one intent may include a plurality of parameters (e.g., a time, the number of iterations, an alarm sound, and the like). For example, the plurality of rules may include one or more necessary parameters. The matching rule may be stored in a natural language understanding database (NLU DB) 221.

According to an embodiment, the NLU module 220 may grasp the meaning of words extracted from a user input by using linguistic features (e.g., grammatical elements) such as morphemes, phrases, and the like and may match the meaning of the grasped words to the domain and intent to determine user intent. For example, the NLU module 220 may calculate how many words extracted from the user input is included in each of the domain and the intent, for the purpose of determining the user intent. According to an embodiment, the NLU module 220 may determine a parameter of the user input by using the words that are the basis for grasping the intent. According to an embodiment, the NLU module 220 may determine the user intent by using the NLU DB 221 storing the linguistic features for grasping the intent of the user input. According to another embodiment, the NLU module 220 may determine the user intent by using a personal language model (PLM). For example, the NLU module 220 may determine the user intent by using the personalized information (e.g., a contact list or a music list). For example, the PLM may be stored in the NLU DB 221. According to an embodiment, the ASR module 210 as well as the NLU module 220 may recognize the voice of the user with reference to the PLM stored in the NLU DB 221.

According to an embodiment, the NLU module 220 may generate a path rule based on the intent of the user input and the parameter. For example, the NLU module 220 may select an app to be executed, based on the intent of the user input and may determine an action to be executed, in the selected app. The NLU module 220 may determine the parameter corresponding to the determined action to generate the path rule. According to an embodiment, the path rule generated by the NLU module 220 may include information about the app to be executed, the action to be executed in the app, and a parameter necessary to execute the action.

According to an embodiment, the NLU module 220 may generate one path rule, or a plurality of path rules based on the intent of the user input and the parameter. For example, the NLU module 220 may receive a path rule set corresponding to the user terminal 100 from the path planner module 230 and may map the intent of the user input and the parameter to the received path rule set for the purpose of determining the path rule.

According to another embodiment, the NLU module 220 may determine the app to be executed, the action to be executed in the app, and a parameter necessary to execute the action based on the intent of the user input and the parameter for the purpose of generating one path rule or a plurality of path rules. For example, the NLU module 220 may arrange the app to be executed and the action to be executed in the app by using information of the user terminal 100 depending on the intent of the user input in the form of ontology or a graph model for the purpose of generating the path rule. For example, the generated path rule may be stored in a path rule database (PR DB) 231 through the path planner module 230. The generated path rule may be added to a path rule set of the PR DB 231.

According to an embodiment, the NLU module 220 may select at least one path rule of the generated plurality of path rules. For example, the NLU module 220 may select an optimal path rule of the plurality of path rules. For another example, when only a part of action is specified based on the user utterance, the NLU module 220 may select a plurality of path rules. The NLU module 220 may determine one path rule of the plurality of path rules depending on an additional input of the user.

According to an embodiment, the NLU module 220 may transmit the path rule to the user terminal 100 in response to a request for the user input. For example, the NLU module 220 may transmit one path rule corresponding to the user input to the user terminal 100. For another example, the NLU module 220 may transmit the plurality of path rules corresponding to the user input to the user terminal 100. For example, when only a part of action is specified based on the user utterance, the plurality of path rules may be generated by the NLU module 220.

According to an embodiment, the path planner module 230 may select at least one path rule of the plurality of path rules.

According to an embodiment, the path planner module 230 may deliver a path rule set including the plurality of path rules to the NLU module 220. The plurality of path rules of the path rule set may be stored in the PR DB 231 connected to the path planner module 230 in the table form. For example, the path planner module 230 may deliver a path rule set corresponding to information (e.g., OS information or app information) of the user terminal 100, which is received from the intelligence agent 151, to the NLU module 220. For example, a table stored in the PR DB 231 may be stored for each domain or for each version of the domain.

According to an embodiment, the path planner module 230 may select one path rule or the plurality of path rules from the path rule set to deliver the selected one path rule or the selected plurality of path rules to the NLU module 220. For example, the path planner module 230 may match the user intent and the parameter to the path rule set corresponding to the user terminal 100 to select one path rule or a plurality of path rules and may deliver the selected one path rule or the selected plurality of path rules to the NLU module 220.

According to an embodiment, the path planner module 230 may generate the one path rule or the plurality of path rules by using the user intent and the parameter. For example, the path planner module 230 may determine the app to be executed and the action to be executed in the app based on the user intent and the parameter for the purpose of generating the one path rule or the plurality of path rules. According to an embodiment, the path planner module 230 may store the generated path rule in the PR DB 231.

According to an embodiment, the path planner module 230 may store the path rule generated by the NLU module 220 in the PR DB 231. The generated path rule may be added to the path rule set stored in the PR DB 231.

According to an embodiment, the table stored in the PR DB 231 may include a plurality of path rules or a plurality of path rule sets. The plurality of path rules or the plurality of path rule sets may reflect the kind, version, type, or characteristic of a device performing each path rule.

According to an embodiment, the DM module 240 may determine whether the user intent grasped by the NLU module 220 is clear. For example, the DM module 240 may determine whether the user intent is clear, based on whether the information of a parameter is sufficient. The DM module 240 may determine whether the parameter grasped by the NLU module 220 is sufficient to perform a task. According to an embodiment, when the user intent is not clear, the DM module 240 may perform a feedback for making a request for necessary information to the user. For example, the DM module 240 may perform a feedback for making a request for information about the parameter for grasping the user intent.

According to an embodiment, the DM module 240 may include a content provider module. When the content provider module executes an action based on the intent and the parameter grasped by the NLU module 220, the content provider module may generate the result obtained by performing a task corresponding to the user input. According to an embodiment, the DM module 240 may transmit the result generated by the content provider module as the response to the user input to the user terminal 100.

According to an embodiment, the natural language generating module NLG 250 may change specified information to a text form. Information changed to the text form may be a form of a natural language utterance. For example, the specified information may be information about an additional input, information for guiding the completion of an action corresponding to the user input, or information for guiding the additional input of the user (e.g., feedback information about the user input). The information changed to the text form may be displayed in the display 120 after being transmitted to the user terminal 100 or may be changed to a voice form after being transmitted to the TTS module 260.

According to an embodiment, the TTS module 260 may change information of the text form to information of a voice form. The TTS module 260 may receive the information of the text form from the NLG module 250, may change the information of the text form to the information of a voice form, and may transmit the information of the voice form to the user terminal 100. The user terminal 100 may output the information of the voice form to the speaker 130.

According to an embodiment, the NLU module 220, the path planner module 230, and the DM module 240 may be implemented with one module. For example, the NLU module 220, the path planner module 230 and the DM module 240 may be implemented with one module, may determine the user intent and the parameter, and may generate a response (e.g., a path rule) corresponding to the determined user intent and parameter. As such, the generated response may be transmitted to the user terminal 100.

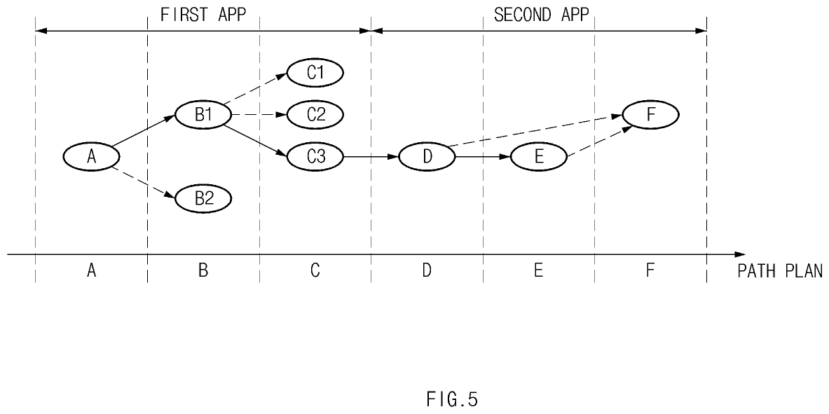

FIG. 5 is a diagram illustrating a method in which an NLU module generates a path rule, according to an embodiment of the disclosure.

Referring to FIG. 5, according to an embodiment, the NLU module 220 may divide the function of an app into unit actions (e.g., A to F) and may store the divided unit actions in the PR DB 231. For example, the NLU module 220 may store a path rule set, which includes a plurality of path rules A-B1-C1, A-B1-C2, A-B1-C3-D-F, and A-B1-C3-D-E-F divided into unit actions, in the PR DB 231.

According to an embodiment, the PR DB 231 of the path planner module 230 may store the path rule set for performing the function of an app. The path rule set may include a plurality of path rules each of which includes a plurality of actions. An action executed depending on a parameter input to each of the plurality of actions may be sequentially arranged in the plurality of path rules. According to an embodiment, the plurality of path rules implemented in a form of ontology or a graph model may be stored in the PR DB 231.

According to an embodiment, the NLU module 220 may select an optimal path rule A-B1-C3-D-F of the plurality of path rules A-B1-C1, A-B1-C2, A-B1-C3-D-F, and A-B1-C3-D-E-F corresponding to the intent of a user input and the parameter.

According to an embodiment, when there is no path rule completely matched to the user input, the NLU module 220 may deliver a plurality of rules to the user terminal 100. For example, the NLU module 220 may select a path rule (e.g., A-B1) partly corresponding to the user input. The NLU module 220 may select one or more path rules (e.g., A-B1-C1, A-B1-C2, A-B1-C3-D-F, and A-B1-C3-D-E-F) including the path rule (e.g., A-B1) partly corresponding to the user input and may deliver the one or more path rules to the user terminal 100.

According to an embodiment, the NLU module 220 may select one of a plurality of path rules based on an input added by the user terminal 100 and may deliver the selected one path rule to the user terminal 100. For example, the NLU module 220 may select one path rule (e.g., A-B1-C3-D-F) of the plurality of path rules (e.g., A-B1-C1, A-B1-C2, A-B1-C3-D-F, and A-B1-C3-D-E-F) depending on the user input (e.g., an input for selecting C3) additionally entered by the user terminal 100 for the purpose of transmitting the selected one path rule to the user terminal 100.

According to another embodiment, the NLU module 220 may determine the intent of a user and the parameter corresponding to the user input (e.g., an input for selecting C3) additionally entered by the user terminal 100 for the purpose of transmitting the user intent or the parameter to the user terminal 100. The user terminal 100 may select one path rule (e.g., A-B1-C3-D-F) of the plurality of path rules (e.g., A-B1-C1, A-B1-C2, A-B1-C3-D-F, and A-B1-C3-D-E-F) based on the transmitted intent or the transmitted parameter.

As such, the user terminal 100 may complete the actions of the apps 141 and 143 based on the selected one path rule.

According to an embodiment, when a user input in which information is insufficient is received by the intelligence server 200, the NLU module 220 may generate a path rule partly corresponding to the received user input. For example, the NLU module 220 may transmit the partly corresponding path rule to the intelligence agent 151. The intelligence agent 151 may transmit the partly corresponding path rule to the execution manager module 153, and the execution manager module 153 may execute the first app 141 depending on the path rule. The execution manager module 153 may transmit information about an insufficient parameter to the intelligence agent 151 while executing the first app 141. The intelligence agent 151 may make a request for an additional input to a user by using the information about the insufficient parameter. When the additional input is received by the user, the intelligence agent 151 may transmit and process the additional input to the intelligence server 200. The NLU module 220 may generate a path rule to be added, based on the intent of the user input additionally entered and parameter information and may transmit the path rule to be added, to the intelligence agent 151. The intelligence agent 151 may transmit the path rule to the execution manager module 153 and may execute the second app 143.

According to an embodiment, when a user input, in which a portion of information is missing, is received by the intelligence server 200, the NLU module 220 may transmit a user information request to the personalization information server 300. The personalization information server 300 may transmit information of a user stored in a persona database to the NLU module 220. The NLU module 220 may select a path rule corresponding to the user input in which a part of an action is missing, by using the user information. As such, even though the user input in which a portion of information is missing is received by the intelligence server 200, the NLU module 220 may make a request for the missing information to receive an additional input or may determine a path rule corresponding to the user input by using user information.

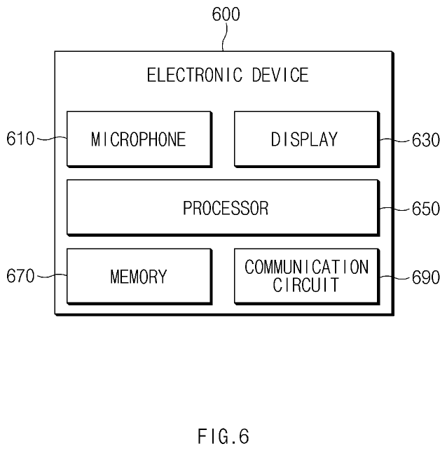

FIG. 6 is a block diagram of an electronic device associated with voice data processing, according to an embodiment of the disclosure. The electronic device 600 illustrated in FIG. 6 may include a configuration that is the same as or similar to the configuration of the user terminal 100 of the above-mentioned drawings.

According to an embodiment, when a hardware key (e.g., the hardware key 112) disposed on one surface of the housing of the electronic device 600 is pressed or when a specified voice (e.g., wake up!) is entered via a microphone 610 (e.g., the microphone 111), the electronic device 600 may launch an intelligence app such as a speech recognition app stored in a memory 670 (e.g., the memory 140). In this case, the electronic device 600 may display the UI (e.g., the UI 121) of the intelligence app on the screen of a display 630 (e.g., the display 120).

According to an embodiment, in a state where the UI of the intelligence app is displayed in the display 630, a user may touch a voice input button (e.g., the speech recognition button 121a) included in the UI of the intelligence app for the purpose of entering a voice. When the voice input button included in the UI of the intelligence app is touched, the electronic device 600 may enter a waiting state for receiving a user's voice input and may receive the user's voice input via the microphone 610 in the waiting state. In addition, when receiving the user's voice input, the electronic device 600 may transmit voice data corresponding to the voice input to an external electronic device (e.g., the intelligence server 200) via a communication circuit 690. In this case, the external electronic device may convert the received voice data to text data, may determine a path rule including information about an action for performing the function of at least one application included in the electronic device 600 or information about a parameter necessary to execute the action, based on the converted text data, and may transmit the determined path rule to the electronic device 600. Afterwards, the electronic device 600 may perform the action depending on the path rule received from the external electronic device.

According to an embodiment, before the electronic device 600 obtains a path rule from the external electronic device, when the electronic device 600 first receives the text data obtained by converting voice data from the external electronic device and then the received text data corresponds to any text displayed on a screen of the display 630, the electronic device 600 may perform the function corresponding to the text data. Furthermore, when the electronic device 600 performs the function corresponding to the text data before obtaining the path rule, the electronic device 600 may not process the path rule obtained from the external electronic device. Accordingly, the electronic device 600 may perform a specific function, for example, the function to process the user input entered through a user input interface (e.g., a button object, an icon, or the like) without a series of steps processed by the external electronic device, that is, an intelligence server.

Referring to FIG. 6, the electronic device 600 performing the above-described function may include a microphone 610, a display 630, a processor 650, a memory 670, and a communication circuit 690. However, a configuration of the electronic device 600 is not limited thereto. According to various embodiments, the electronic device 600 may further at least other components in addition to the aforementioned components. For example, the electronic device 600 may further include a speaker (e.g., the speaker 130) that outputs the voice signal generated in the electronic device 600 to the outside, for the purpose of notifying a user of the processing result of the voice input. For example, the speaker may convert an electrical signal to vibration to transmit sound waves into the air.

According to an embodiment, the microphone 610 may receive the user's utterance as the voice signal. For example, the microphone 610 may convert the vibration energy caused by the user's utterance into an electrical signal and may transmit the converted electrical signal to the processor 650.

According to an embodiment, the display 630 may display various content (e.g., texts, images, video, icons, symbols, or the like) to the user. According to an embodiment, the display 630 may include a touch screen. For example, the display 630 may obtain a touch, gesture, proximity, or a hovering input using an electronic pen or a part of the user's body (e.g., a finger).

According to an embodiment, the processor 650 may perform data processing or an operation associated with control and/or communication of at least one other component(s) of the electronic device 600. For example, the processor 650 may drive an operating system (OS) or an application program to control a plurality of hardware or software components connected to the processor 650 and may process a variety of data or may perform an arithmetic operation. The processor 650 may include one or more of a central processing unit (CPU), an application processor (AP), or a communication processor (CP). According to an embodiment, the processor 650 may be implemented with a system-on-chip (SoC).

According to an embodiment, the processor 650 may launch an application (e.g., intelligence app) stored in the memory 670 and may output the execution screen of an application to the display 630. For example, the processor 650 may organize the context (e.g., UI) associated with an application in a screen to output the content to the display 630.

According to an embodiment, when the voice input button is selected, the processor 650 may enter a waiting state for receiving a voice input. For example, the waiting state may be a state where the microphone 610 is activated such that a voice input is possible. Furthermore, for the purpose of notifying the user that the processor 650 enters the waiting state, the processor 650 may output the screen associated with the waiting state to the display 630. For example, the processor 650 may notify the display 630 that the microphone 610 has been activated, and thus, may notify the user that the voice input is possible.

According to an embodiment, when the voice input is received via the microphone 610, the processor 650 may transmit voice data corresponding to the voice input to an external electronic device (e.g., the intelligence server 200) via the communication circuit 690. Moreover, the processor 650 may receive text data generated by converting the voice data into the text format, from the external electronic device via the communication circuit 690.

According to an embodiment, the processor 650 may collect the screen configuration information of the display 630. For example, the processor 650 may identify a state where at least a piece of content displayed on a screen is organized. The screen configuration information may include information about at least a piece of content displayed on the screen. For example, information about the content may include identification information of the content, a type of content, information about coordinates at which the content is displayed, visual information of the content, or the like. The identification information of content may include unique information capable of distinguishing content. The type of content may include, for example, a text, an image, a video, an icon, a symbol, or the like. For example, the coordinate information may include the location value of a pixel on the horizontal and vertical axes when the screen is divided into a plurality of pixels formed in a lattice structure. For example, the visual information of content may include data recognized by a user when the content is displayed on a screen. For example, when the type of content is a text, the visual information of the content may correspond to text data. For example, when the type of content is an image, the visual information of the content may correspond to image data. In the following description, only the case where the type of content is a text will be described.

According to an embodiment, the processor 650 may obtain the screen configuration information from an application by which the execution screen is output on the current screen. The application may deliver information (e.g., identification information of a text, information about coordinates at which a text is displayed, text data, or the like) about at least one text organizing the execution screen to the processor 650 at the request of the processor 650. In any embodiment, the processor 650 may obtain the screen configuration information from only the single application being executed in foreground.

According to an embodiment, the processor 650 may compare the text data obtained from the intelligence server 200 with at least one text data included in the screen configuration information. The processor 650 may determine whether at least one text is displayed on the screen and text data of the text is the same as the text data obtained from the intelligence server 200. For example, the processor 650 may determine whether the result of converting voice data corresponding to the voice of a user in the text format is the same as the content in the text format displayed on a screen.

According to an embodiment, the function corresponding to the text data may include, for example, the function mapped to content corresponding to the text data. For example, when the text data is “Internet” and when the text data is mapped to the execution function of an Internet connection application, the processor 650 may execute the Internet connection application.

According to an embodiment, the processor 650 may identify the function corresponding to the text data, using the screen configuration information. For example, when text data the same as the text data obtained from the intelligence server 200 is included in the screen configuration information, the processor 650 may identify identification information of a text corresponding to the text data and may identify a function mapped to the identification information of the text among functions defined in an application, using the identification information of the text.

According to an embodiment, when the result of comparing the pieces of text data (the text data obtained from the intelligence server 200 and at least one text data included in the screen configuration information) indicates that the same pieces of text data as each other are present, the processor 650 may perform the function corresponding to the same text data. According to an embodiment, for the purpose of performing the function, the processor 650 may generate a touch event as if a touch input is generated at coordinates at which a text corresponding to the text data is displayed and then may deliver the generated touch event to an application organizing the execution screen including the text. That is, the processor 650 may deliver the related signal (a touch event) to the application so as to operate as if the text is selected (touched) in the execution screen of the application.

According to an embodiment, the processor 650 may manage history information about the function execution. For example, the processor 650 may store information capable of determining whether the function is performed, in the memory 670.

According to an embodiment, the processor 650 may receive a path rule including information about an action for performing the function of at least one application stored in the memory 670 or information about a parameter necessary to perform the action, from an external electronic device (e.g., the intelligence server 200) via the communication circuit 690. When receiving the path rule, the processor 650 may determine whether to process the path rule, depending on whether the function is performed (e.g., whether a function corresponding to text data the same as the text data corresponding to a voice of a user in text data displayed on a screen is performed). For example, when there is a history in which the function is performed (when the function is performed already), the processor 650 may not process the path rule. That is, after the function is performed, the processor 650 may ignore the path rule received from the intelligence server 200. For another example, when there is no history in which the function is performed (when the function is not performed already), the processor 650 may perform actions defined to perform the function of the at least one application, depending on the path rule.

In any embodiment, when there is a history in which the function is performed, that is, when a function corresponding to text data the same as text data corresponding to the voice of a user in the text data displayed on a screen is performed, the processor 650 may notify the intelligence server 200 that the function has been performed. For example, the processor 650 may transmit a signal for providing a notification that the function has been performed, to the intelligence server 200 via the communication circuit 690. In this case, the intelligence server 200 may not transmit the path rule to the electronic device 600.

According to an embodiment, the memory 670 may store a command or data associated with at least another component of the electronic device 600. According to an embodiment, the memory 670 may store software and/or a program. For example, the memory 670 may store an application (e.g., an intelligence app) associated with an AI technology. For example, the intelligence app may include instructions associated with the function that receives and processes the user's utterance as a voice signal, instructions for collecting information about content organized in a screen, that is, screen configuration information, instructions for comparing the result (text data obtained by converting voice data in the text format) obtained by processing voice data according to the user's utterance with text data included in the screen configuration information, or instructions for performing the function corresponding to the text data when the comparison result indicates that the same text data is present. However, instructions included in the intelligence app are not limited thereto. According to various embodiments, the intelligence app may further include at least another instruction in addition to the above-mentioned instructions, and at least one of the above-mentioned instructions may be omitted. In addition, software stored in the memory 670 and/or instructions included in a program may be loaded onto a volatile memory by the processor 650 and may be processed depending on a specified program routine.

According to an embodiment, the communication circuit 690 may support the communication channel establishment between the electronic device 600 and an external electronic device (e.g., the intelligence server 200, the personalization information server 300, or the suggestion server 400) and the execution of wired or wireless communication through the established communication channel.

As described above, according to various embodiments, an electronic device (e.g., the electronic device 600 may include a microphone (e.g., the microphone 610), a communication circuit (e.g., the communication circuit 690), a display (e.g., the display 630), a memory (e.g., the memory 670) storing at least one application and a processor (e.g., the processor 650) electrically connected to the microphone, the communication circuit, the display, and the memory. The processor may be configured to obtain voice data corresponding to a voice of a user received via the microphone to obtain first information about at least one text displayed on a screen of the display, to transmit the voice data to an external electronic device via the communication circuit to receive first text data converted based on the voice data from the external electronic device via the communication circuit, to determine whether second text data the same as the first text data is present in the first information, to execute a first function corresponding to the second text data, using the first information when the second text data is present, to receive second information configured to execute a second function of the at least one application, from the external electronic device via the communication circuit, and to execute the second function when the first function is not executed and restrict processing of the second information when the first function is executed.

According to various embodiments, the first information may include at least one of identification information of the at least one text, coordinate information at which the at least one text is displayed, and text data corresponding to the at least one text.

According to various embodiments, the processor may be configured to determine coordinates at which a text corresponding to the second text data is displayed on the screen, based on the coordinate information and to generate a signal associated with occurrence of a touch input at the coordinates.

According to various embodiments, the processor may be configured to transmit the signal to an application organizing the screen, on which the text corresponding to the second text data is displayed, from among the at least one application.

According to various embodiments, the processor may be configured to transmit the signal to an application, which is being executed in foreground, from among the at least one application.

According to various embodiments, the processor may be configured to store history information about the execution of the first function, in the memory.

According to various embodiments, the processor may be configured to determine whether the first function is executed, based on the history information.

According to various embodiments, the second information may include at least one of information about an action for executing the second function, information about a parameter necessary to execute the action, and order information of the action.

As described above, according to various embodiments, an electronic device (e.g., the electronic device 600 may include a microphone (e.g., the microphone 610), a communication circuit (e.g., the communication circuit 690), a display (e.g., the display 630), a memory (e.g., the memory 670) storing at least one application and a processor (e.g., the processor 650) electrically connected to the microphone, the communication circuit, the display, and the memory. The processor may be configured to obtain voice data corresponding to a voice of a user received via the microphone to obtain first information about at least one text displayed on a screen of the display, to transmit the voice data to an external electronic device via the communication circuit to receive first text data converted based on the voice data from the external electronic device via the communication circuit, to determine whether second text data the same as the first text data is present in the first information, to execute a first function corresponding to the second text data, using the first information when the second text data is present, and to enter a waiting state for receiving second information configured to execute a second function of the at least one application when the second text data is not present.

According to various embodiments, the processor may be configured to transmit information for providing a notification that the first function has been executed, to the external electronic device via the communication circuit when the first function is executed.

According to various embodiments, the first information may include at least one of identification information of the at least one text, coordinate information at which the at least one text is displayed, and text data corresponding to the at least one text.

According to various embodiments, the processor may be configured to determine coordinates at which a text corresponding to the second text data is displayed on the screen, based on the coordinate information and to generate a signal associated with occurrence of a touch input at the coordinates.

According to various embodiments, the second information may include at least one of information about an action for executing the second function, information about a parameter necessary to execute the action, and order information of the action.

According to various embodiments, the processor may be configured to execute the second function based on the second information when receiving the second information from the external electronic device via the communication circuit in the waiting state.

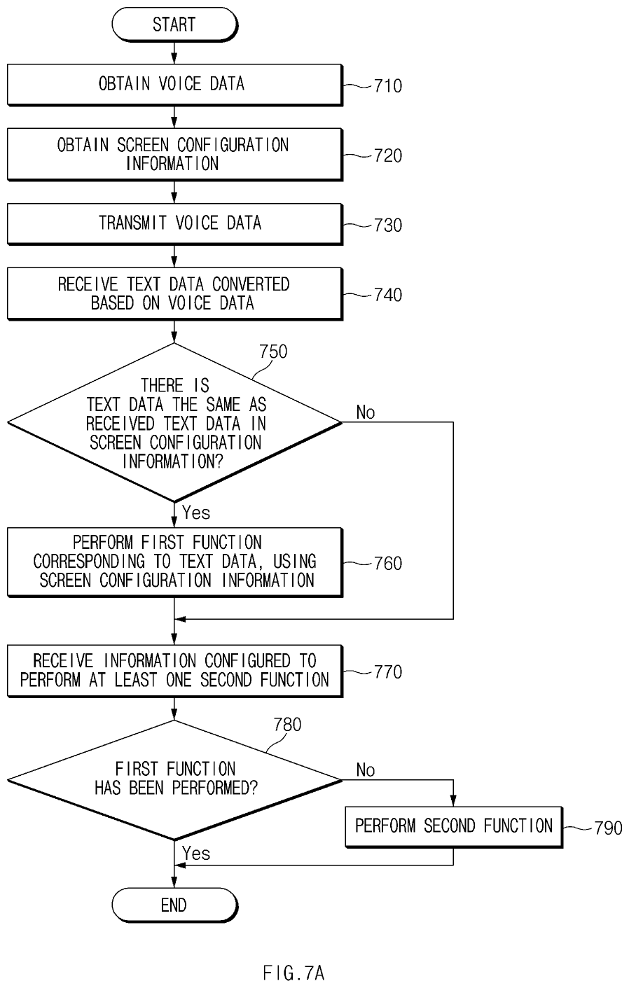

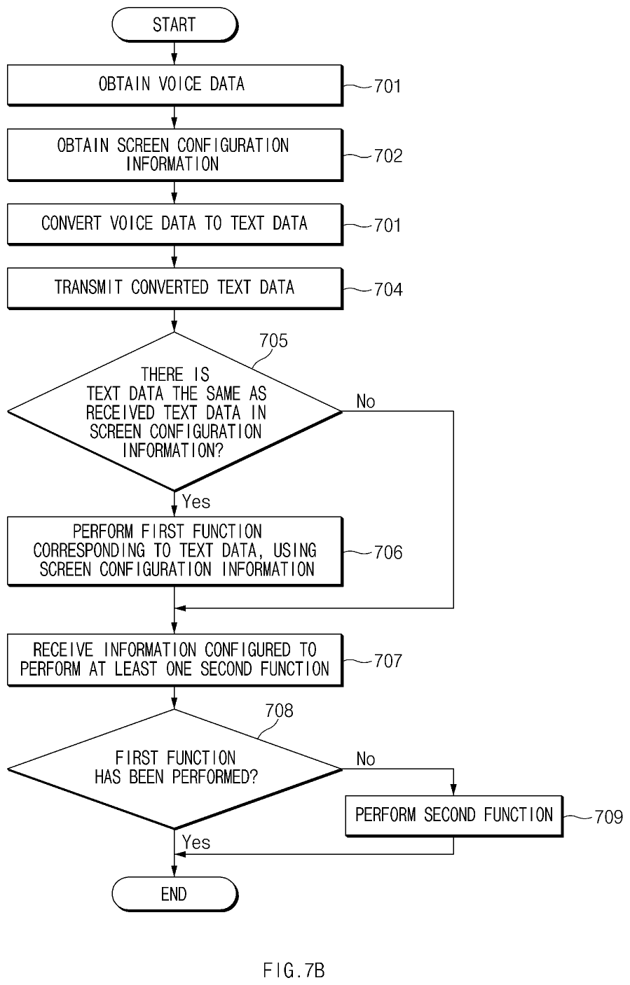

FIG. 7A is a flowchart illustrating an operating method of an electronic device associated with voice data processing, according to an embodiment of the disclosure.

Referring to FIG. 7, in operation 710, the processor (e.g., the processor 650) of an electronic device (e.g., the electronic device 600) according to an embodiment may obtain voice data. For example, when a user speaks a voice, the processor may obtain the voice data corresponding to the voice via a microphone (e.g., the microphone 610).

In operation 720, the processor according to an embodiment may obtain screen configuration information. The screen configuration information may include information about at least one text displayed on the screen of a display (e.g., the display 630). For example, the information about the text may include identification information of a text, information about coordinates at which the text is displayed, text data, or the like. For example, the processor may obtain the screen configuration information from an application by which the execution screen is output on the current screen. For another example, the processor may obtain the screen configuration information in foreground from only the single application being executed. According to an embodiment, the processor may perform operation 720 after performing operation 730 (or operation 740) before performing operation 750.

In operation 730, the processor according to an embodiment may transmit the obtained voice data to an external electronic device (e.g., the intelligence server 200) via a communication circuit (e.g., the communication circuit 690). In this case, the external electronic device may convert the received voice data to text data. Furthermore, the external electronic device may transmit the converted text data to the electronic device.

In operation 740, the processor according to an embodiment may receive the text data from the external electronic device via the communication circuit. The text data may be data obtained by converting the voice data in the text format.

In operation 750, the processor according to an embodiment may determine whether there is text data the same as text data received from the external electronic device in the screen configuration information. For example, the processor may compare at least one text data included in the screen configuration information with the text data received from the external electronic device.

When the result of comparing the pieces of text data indicates that there is the same text data, in operation 760, the processor according to an embodiment may perform a first function corresponding to the same text data, using the screen configuration information. For example, the processor may identify identification information of a text corresponding to the same text data, using the screen configuration information, may identify the first function mapped to the identification information of the text among functions defined in an application, using the identification information of the text, and may perform the first function. In any embodiment, for the purpose of performing the first function, the processor may generate a touch event as if a touch input is generated at coordinates at which a text corresponding to the text data is displayed and then may deliver the generated touch event to an application organizing the execution screen including the text. That is, the processor may deliver the related signal (a touch event) to the application so as to operate as if the text is selected (touched) in the execution screen of the application.

When the result of comparing the pieces of text data indicates that the same text data is not present or after performing operation 760, in operation 770, the processor according to an embodiment may receive information configured to perform at least one second function from the external electronic device via the communication circuit. The information configured to perform the second function may correspond to the path rule in the above-described drawings. That is, when receiving voice data in operation 730, the external electronic device may convert the voice data to text data, may determine a path rule including information about an action for performing the second function of at least one application included in the electronic device or information about a parameter necessary to execute the action, based on the converted text data, and may transmit the determined path rule to the electronic device.

In operation 780, the processor according to an embodiment may determine whether the first function has been performed. According to an embodiment, the processor may manage history information about the execution of the first function. For example, after performing operation 760, the processor may store information capable of determining whether the first function is performed, in a memory (e.g., the memory 670). In this case, the processor may determine whether the first function has been performed, using the history information about the execution of the first function stored in the memory.

When the first function is not performed, in operation 790, the processor according to an embodiment may perform the second function. For example, the processor may perform the second function depending on the path rule received from the external electronic device. When the first function is performed, the processor may not process the path rule received from the external electronic device.

FIG. 7B is a flowchart illustrating an operating method of an electronic device associated with voice data processing, according to another embodiment of the disclosure. The operating method of an electronic device in FIG. 7B is similar to the operating method of the electronic device in FIG. 7A. However, an operation of converting voice data obtained in FIG. 7A to text data may be performed by an external electronic device (e.g., the intelligence server 200); on the other hand, the operation may be performed by an electronic device in FIG. 7B.

Referring to FIG. 7B, a processor (e.g., the processor 650) of an electronic device (e.g., the electronic device 600) according to an embodiment may obtain voice data via a microphone (e.g., the microphone 610) in operation 701, and may obtain information about at least one text displayed on a screen of a display (e.g., the display 630), that is, screen configuration information in operation 702.

In operation 703, the processor according to an embodiment may convert the obtained voice data to text data. For example, the processor may convert voice data in the text format, instead of receiving the text data converted via the intelligence server 200. Furthermore, in operation 740, the processor according to an embodiment may transmit the converted text data to an external electronic device (e.g., the intelligence server 200). When the external electronic device receives the converted text data, the external electronic device may determine a user's intent and a keyword based on the text data and may determine a path rule based on the user's intent and the keyword.

In operation 705, the processor according to an embodiment may determine whether there is text data the same as the converted text data in the screen configuration information.

When the result of comparing the pieces of text data indicates that there is the same text data, in operation 706, the processor according to an embodiment may perform a first function corresponding to the same text data, using the screen configuration information. According to an embodiment, for the purpose of performing the first function, the processor may generate a touch event as if a touch input is generated at coordinates at which a text corresponding to the text data is displayed and then may deliver the generated touch event to an application organizing the execution screen including the text.

When the result of comparing the pieces of text data indicates that the same text data is not present or after performing operation 706, in operation 707, the processor according to an embodiment may receive information configured to perform at least one second function from the external electronic device via the communication circuit. The information configured to perform the second function may correspond to the path rule in the above-described drawings.

In operation 708, the processor according to an embodiment may determine whether the first function has been performed. When the first function is not performed, in operation 709, the processor according to an embodiment may perform the second function. For example, the processor may perform the second function depending on the path rule received from the external electronic device. When the first function is performed, the processor according to an embodiment may not process the path rule received from the external electronic device.

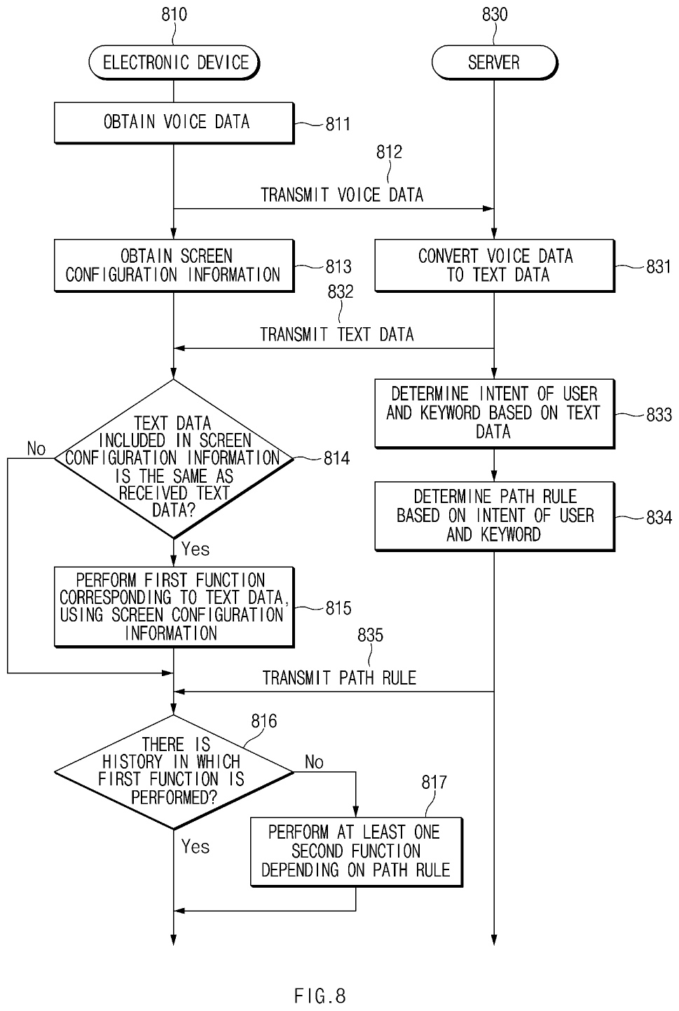

FIG. 8 is a block diagram illustrating an operating method of a system associated with voice data processing, according to an embodiment of the disclosure.

Referring to FIG. 8, in operation 811, an electronic device 810 (e.g., the electronic device 600) according to an embodiment may obtain voice data; in operation 812, an electronic device 810 may transmit the obtained voice data to a server 830 (e.g., the intelligence server 200). The voice data may be data corresponding to the voice by a user's utterance; in a state where an intelligence app such as a voice recognition app is executed, the voice data may be obtained via a microphone (e.g., the microphone 610).

Afterward, in operation 813, an electronic device 810 according to an embodiment may obtain screen configuration information. For example, the electronic device 810 may obtain information about at least one text displayed on a screen of a display (e.g., the display 630) from an application by which the execution screen is output to the current screen. At a point in time the same as or nearly similar to this, in operation 831, the server 830 according to an embodiment may convert the voice data received from the electronic device 810 to text data. Moreover, in operation 832, the server 830 may transmit the converted text data to the electronic device 810.

When receiving the converted text data from the server 830, in operation 814, the electronic device 810 according to an embodiment may compare text data included in the screen configuration information with the received text data. When the result of comparing the pieces of text data indicates that there is the same text data, in operation 815, the electronic device 810 according to an embodiment may perform a first function corresponding to the same text data, using the screen configuration information. According to an embodiment, for the purpose of performing the first function, the electronic device 810 may generate a touch event as if a touch input is generated at coordinates at which a text corresponding to the text data is displayed and then may deliver the generated touch event to an application organizing the execution screen including the text. That is, the electronic device 810 may deliver the related a touch event to the application so as to operate as if the text is touched in the execution screen of the application.

At a point in time the same as or nearly similar to this, in operation 833, the server 830 according to an embodiment may determine the utterance intent of a user and a keyword based on the converted text data. Furthermore, in operation 834, the server 830 according to an embodiment may determine a path rule based on the intent of the user and the keyword. For example, the path rule may include information about the action for performing the second function of at least one application included in the electronic device 810 or information about a parameter necessary to perform the action.

When the path rule is determined, in operation 835, the server 830 may transmit the determined path rule to the electronic device 810. Generally, a point in time when the path rule is transmitted may be after a point in time when the first function is completed. The reason is that a time period in which operation 833 of determining the user's intent and the keyword based on the text data and operation 834 of determining a path rule based on the user's intent and the keyword are performed is longer than a time period in which operation 814 of comparing the pieces of text data in the electronic device 810 and operation 815 of performing the first function are performed. However, operation 835 may be performed before performing operation 814 or operation 815. In any embodiment, operation 835 may be first performed operation 814 or operation 815. In this case, the electronic device 810 may skip the execution of operation 814 (and operation 815) and may perform operation 816; alternatively, the electronic device 810 may wait for the execution of operation 816 until the execution of operation 814 (and operation 815) is completed.

When receiving the path rule, in operation 816, the electronic device 810 may determine whether the first function is performed. For example, the electronic device 810 may determine whether the first function is performed, using history information about the execution of the first function.

When the first function is not performed (e.g., when there is no history in which the first function is performed), in operation 817, the electronic device 810 may perform at least one second function depending on the path rule received from the server 830. When the first function is performed (e.g., when there is a history in which the first function is performed), the electronic device 810 according to an embodiment may not process the path rule.

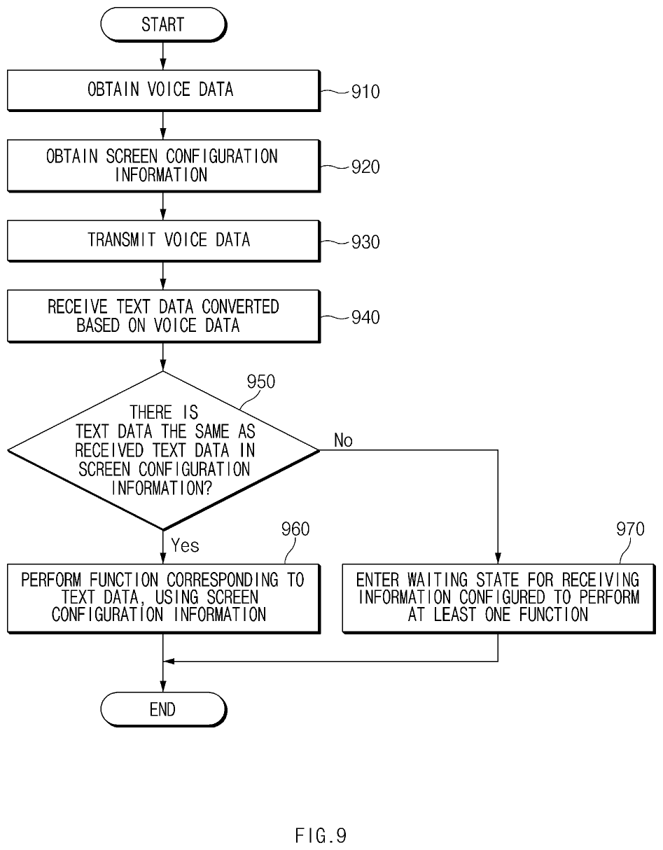

FIG. 9 is a view illustrating another operating method of an electronic device associated with voice data processing, according to an embodiment of the disclosure. The operations in FIG. 9 may be the same as or similar to the operations in FIG. 7A. However, the operations in FIG. 9 may be different from the operations in FIG. 7A when the text data displayed on a screen is the same as text data received from the intelligence server 200.

Referring to FIG. 9, in operation 910, the processor (e.g., the processor 650) of an electronic device (e.g., the electronic device 600) according to an embodiment may obtain voice data. For example, when a user speaks a voice, the processor may obtain the voice data corresponding to the voice via a microphone (e.g., the microphone 610).

In operation 920, the processor according to an embodiment may obtain screen configuration information. The screen configuration information may include information about at least one text displayed on the screen of a display (e.g., the display 630). According to an embodiment, the processor may perform operation 920 after performing operation 930 (or operation 940) before performing operation 950.

In operation 930, the processor according to an embodiment may transmit the obtained voice data to an external electronic device (e.g., the intelligence server 200) via a communication circuit (e.g., the communication circuit 690). In this case, the external electronic device may convert the received voice data to text data. Furthermore, the external electronic device may transmit the converted text data to the electronic device.

In operation 940, the processor according to an embodiment may receive the text data from the external electronic device via the communication circuit. The text data may be data obtained by converting the voice data in the text format.

In operation 950, the processor according to an embodiment may determine whether there is text data the same as text data received from the external electronic device in the screen configuration information. For example, the processor may compare at least one text data included in the screen configuration information with text data received from the external electronic device.

When the result of comparing the pieces of text data indicates that there is the same text data, in operation 960, the processor according to an embodiment may perform a function (e.g., the first function of FIG. 7A) corresponding to the same text data, using the screen configuration information. For example, the processor may identify identification information of a text corresponding to the same text data, using the screen configuration information, may identify a function (e.g., the first function of FIG. 7A) mapped to the identification information of the text among functions defined in an application, using the identification information of the text, and may perform the function (e.g., the first function of FIG. 7A). In any embodiment, for the purpose of performing the function (e.g., the first function of FIG. 7A), the processor may generate a touch event as if a touch input is generated at coordinates at which a text corresponding to the text data is displayed and then may deliver the generated touch event to an application organizing the execution screen including the text. That is, the processor may deliver the related touch event to the application so as to operate as if the text is touched in the execution screen of the application.

When the result of comparing the pieces of text data indicates that the same text data is not present, in operation 970, the processor according to an embodiment may enter a waiting state for receiving information configured to perform at least one function (e.g., the second function in FIG. 7A) from the external electronic device via the communication circuit. For example, the processor may determine a path rule including information about an action, in which the external electronic device performs the function (e.g., the second function in FIG. 7A) of at least one application included in the electronic device based on the converted text data, or information about a parameter necessary to perform the action and may wait until the determined path rule is transmitted to the electronic device.

After operation 970, although omitted in drawing, the processor according to an embodiment may receive the determined path rule from the external electronic device via the communication circuit and may perform the function (e.g., the second function in FIG. 7A) depending on the received path rule.

In FIG. 9, unlike the description given with reference to FIG. 7A, when the text data displayed on a screen is the same as the text data received from the external electronic device, a path rule may not be received from the external electronic device. As a result, the electronic device in FIG. 9 may not receive the path rule scheduled to be not processed, thereby skipping the unnecessary operation. According to an embodiment, for the purpose of not receiving the path rule, the processor may transmit a notification that a path rule needs to be not transmitted after performing operation 960, to the external electronic device.

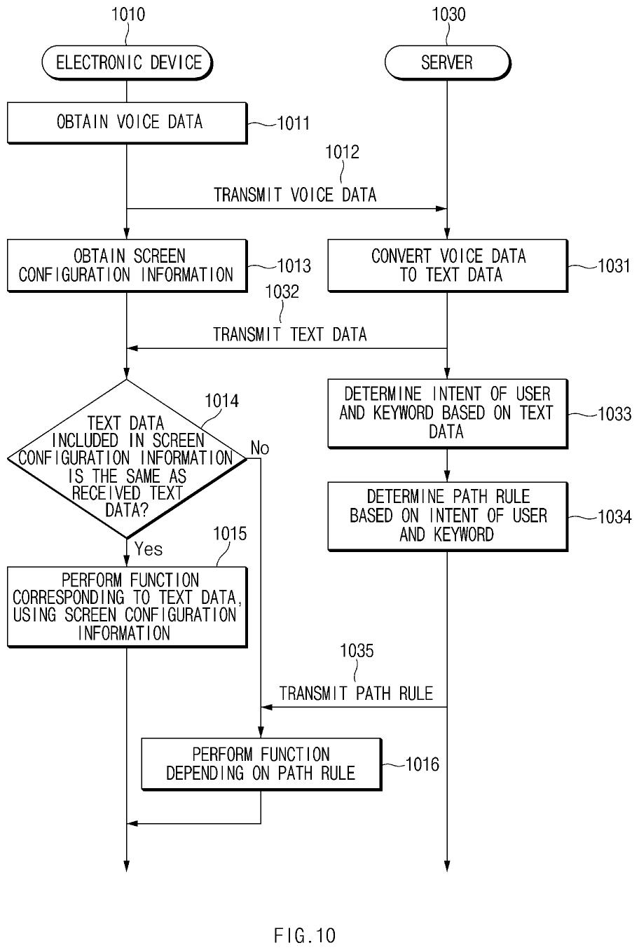

FIG. 10 is a view illustrating another operating method of a system associated with voice data processing, according to an embodiment of the disclosure. The operations in FIG. 10 may be the same as or similar to the operations in FIG. 8. However, the operations in FIG. 10 may be different from the operations in FIG. 8 when the text data displayed on a screen is the same as text data received from the intelligence server 200.

Referring to FIG. 10, in operation 1011, an electronic device 1010 (e.g., the electronic device 600) according to an embodiment may obtain voice data; in operation 1012, an electronic device 1010 may transmit the obtained voice data to a server 1030 (e.g., the intelligence server 200). The voice data may be data corresponding to the voice by a user's utterance; in a state where an intelligence app such as a voice recognition app is executed, the voice data may be obtained via a microphone (e.g., the microphone 610).

Afterward, in operation 1013, an electronic device 1010 according to an embodiment may obtain screen configuration information. For example, the electronic device 1010 may obtain information about at least one text displayed on a screen of a display (e.g., the display 630) from an application by which the execution screen is output to the current screen. At a point in time the same as or nearly similar to this, in operation 1031, the server 1030 may convert the voice data received from the electronic device 1010 according to an embodiment to text data. Moreover, in operation 1032, the server 1030 according to an embodiment may transmit the converted text data to the electronic device 1010.

When receiving the converted text data from the server 1030, in operation 1014, the electronic device 1010 according to an embodiment may compare text data included in the screen configuration information with the received text data. When the result of comparing the pieces of text data indicates that there is the same text data, in operation 1015, the electronic device 1010 according to an embodiment may perform a function (e.g., the first function in FIG. 8) corresponding to the same text data, using the screen configuration information. According to an embodiment, for the purpose of performing the function (e.g., the first function in FIG. 8), the electronic device 1010 may generate a touch event as if a touch input is generated at coordinates at which a text corresponding to the text data is displayed and then may deliver the generated touch event to an application organizing the execution screen including the text. That is, the electronic device 1010 may deliver the related a touch event to the application so as to operate as if the text is touched in the execution screen of the application.

When the result of comparing the pieces of text data indicates that the same text data is not present, the electronic device 1010 according to an embodiment may enter a waiting state for receiving information configured to perform at least one function (e.g., the second function in FIG. 8) from the server 1030 via a communication circuit (e.g., the communication circuit 690). For example, the electronic device 1010 may wait until operation 1035 is performed.

In operation 1033, the server 1030 according to an embodiment may determine the utterance intent of a user and a keyword based on the converted text data. Furthermore, in operation 1034, the server 1030 according to an embodiment may determine a path rule based on the intent of the user and the keyword. For example, the path rule may include information about the action for performing the function (e.g., the second function in FIG. 8) of at least one application included in the electronic device 1010 or information about a parameter necessary to perform the action.

When the path rule is determined, in operation 1035, the server 1030 may transmit the determined path rule to the electronic device 1010. When receiving the path rule, in operation 1016, the electronic device 1010 according to an embodiment may perform at least one function (e.g., the second function in FIG. 8) depending on the path rule received from the server 1030.

In FIG. 10, unlike the description given with reference to FIG. 8, when the text data displayed on a screen is the same as the text data received from the server 1030, a path rule may not be received from the server 1030. As a result, the electronic device 1010 in FIG. 10 may not receive the path rule scheduled to be not processed, thereby skipping the unnecessary operation. According to an embodiment, for the purpose of not receiving the path rule, the electronic device 1010 may transmit a notification that a path rule needs to be not transmitted after performing operation 1015, to the server 1030.

As described above, according to various embodiments, a voice data processing method of an electronic device (e.g., the electronic device 600) may include obtaining voice data corresponding to a voice of a user received via a microphone, obtaining first information about at least one text displayed on a screen of a display, transmitting the voice data to an external electronic device via a communication circuit, receiving first text data converted based on the voice data, from the external electronic device via the communication circuit, determining whether second text data the same as the first text data is present in the first information, executing a first function corresponding to the second text data, using the first information when the second text data is present, receiving second information configured to execute a second function of at least one application stored in a memory, from the external electronic device via the communication circuit, determining whether the first function is executed, executing the second function when the first function is not executed, and restricting processing of the second information when the first function is executed.

According to various embodiments, the executing of the first function may include determining coordinates at which a text corresponding to the second text data is displayed on the screen, based on the coordinate information at which the at least one text included in the first information is displayed and generating a signal associated with occurrence of a touch input at the coordinates.

According to various embodiments, the voice data processing method may further include transmitting the signal to an application organizing the screen, on which the text corresponding to the second text data is displayed, from among the at least one application.

According to various embodiments, the voice data processing method may further include transmitting the signal to an application, which is being executed in foreground, from among the at least one application.

According to various embodiments, the voice data processing method may further include storing history information about the execution of the first function, in the memory.

According to various embodiments, the determining of whether the first function is executed may include determining whether the first function is executed, based on the history information about the execution of the first function.

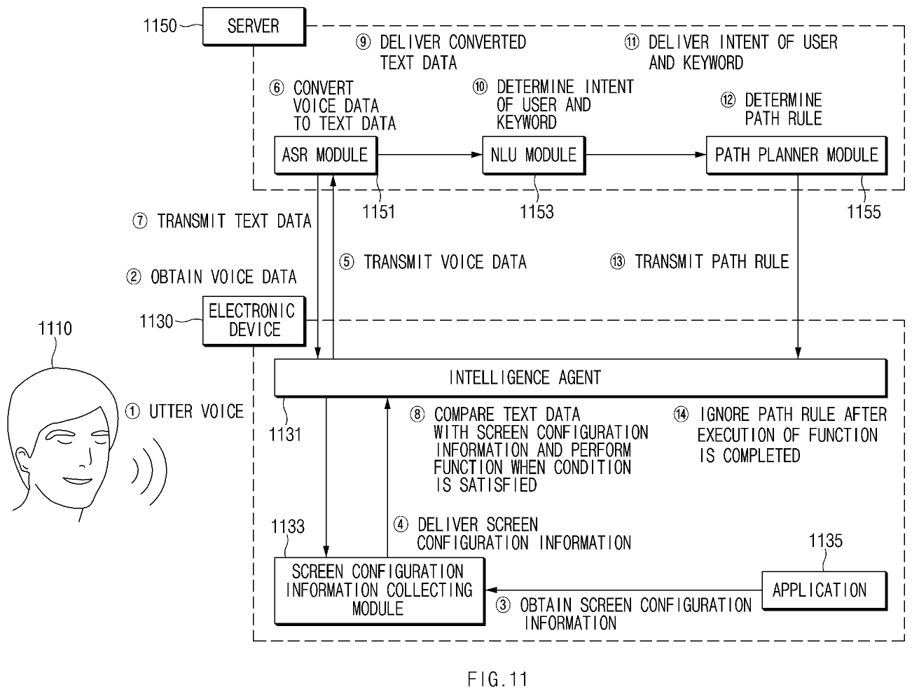

FIG. 11 is a block diagram of a system associated with voice data processing, according to an embodiment of the disclosure.

Referring to FIG. 11, when a user 1110 utters a voice, an electronic device 1130 (e.g., the electronic device 600) according to an embodiment may obtain voice data corresponding to the user's voice via a microphone. Furthermore, a screen configuration information collecting module 1133 included in the electronic device 1130 may collect information about at least one text displayed on the current screen, that is, screen configuration information. According to an embodiment, the screen configuration information collecting module 1133 may obtain the screen configuration information from an application 1135 by which an execution screen is output to the current screen. For example, the information about the text may include identification information of a text, information about coordinates at which the text is displayed, text data, or the like.

When the screen configuration information is collected, the screen configuration information collecting module 1133 according to an embodiment may deliver the screen configuration information collected by an intelligence agent 1131 (e.g., the intelligence agent 151).

After the voice data is received or after the screen configuration information is collected, the intelligence agent 1131 according to an embodiment may transmit the voice data received by an ASR module 1151 (e.g., the ASR module 210) of a server 1150 (e.g., the intelligence server 200). At this time, the ASR module 1151 may convert the received voice data to text data.

When the conversion to the text data is completed, the ASR module 1151 according to an embodiment may deliver the converted text data to an NLU module 1153 (e.g., the NLU module 220) of the server 1150, at a point in time the same or similar to at a point in time when transmitting the converted text data to the intelligence agent 1131.

According to an embodiment, the intelligence agent 1131 receiving the text data from the ASR module 1151 may compare the received text data with at least one text data included in the screen configuration information and may perform the function corresponding to the text data when the result of comparing the pieces of text data indicates that there is the same text data.

According to an embodiment, the NLU module 1153 receiving the text data from the ASR module 1151 may determine a user's intent and a keyword based on the text data. Furthermore, the NLU module 1153 according to an embodiment may deliver information about the determined intent of the user and the determined keyword to a path planner module 1155 (e.g., the path planner module 230) of the server 1150. The path planner module 1155 according to an embodiment may determine a path rule, using the received information about the intent of the user and the keyword.

When the path rule is determined, the path planner module 1155 according to an embodiment may transmit the determined path rule to the intelligence agent 1131. According to an embodiment, after the result of comparing the pieces of text data indicates that there is the same text data and the function corresponding to the text data is performed, the intelligence agent 1131 receiving the path rule may not process the received path rule. That is, the intelligence agent 1131 may ignore the received path rule.

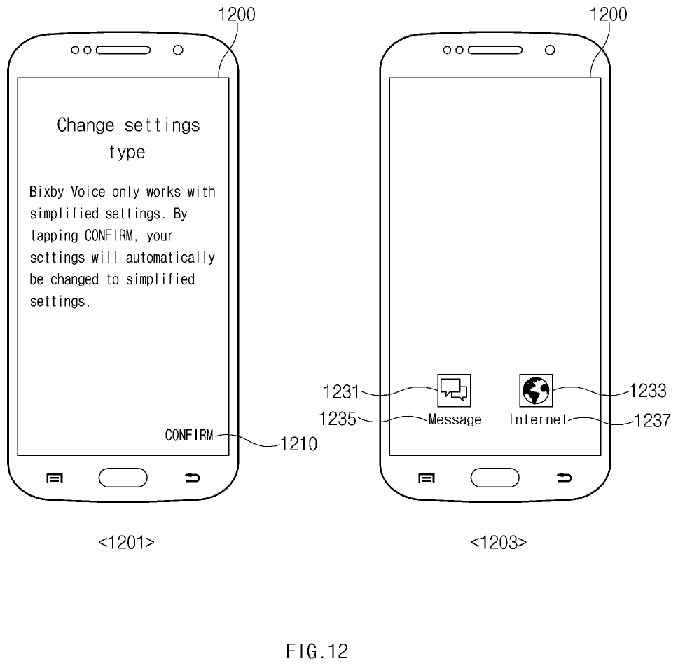

FIG. 12 is a view for describing screen configuration information, according to an embodiment of the disclosure.

Referring to FIG. 12, the screen configuration information in the above-described drawings may include information about at least a piece of content displayed on the screen. For example, information about the content may include identification information of the content, a type of content, information about coordinates at which the content is displayed, visual information of the content, or the like.

According to an embodiment, when text data obtained by converting voice data of a user from the intelligence server 200 is the same as any text data included in the screen configuration information, an electronic device (e.g., the electronic device 600) may perform a function corresponding to the same text data. However, the function may not be performed on all pieces of text data displayed on a screen 1200. For example, the electronic device may perform the function on only the text data mapped to the function of a user input interface (e.g., a button object, an icon, or the like) among text data displayed on the screen 1200.

For example, when text data not mapped to the function of a user input interface in text data displayed on a screen 1200 is uttered, the electronic device may wait until receiving a path rule associated with the execution of a function from the intelligence server 200, without performing the function associated with the text data. In any embodiment, the electronic device may not map any function to the text data not mapped to the function of the user input interface. In this case, the electronic device may not perform any function regardless of determining whether the text data is mapped to the function of the user input interface.

Referring to the text data mapped to the function of the user input interface, as illustrated in a first state 1201, it may be seen that the text data is mapped to a button object 1210 displayed on the screen 1200. For example, when the text data (e.g., “CONFIRM”) mapped to the button object 1210 displayed on a specific region of the screen 1200 is uttered by a user, the electronic device may perform the function of the button object 1210. For example, the electronic device may allow the button object 1210 to operate as if the button object 1210 is selected (or touched). For example, an electronic device may generate a touch event as if a touch input is generated at coordinates where the button object 1210 is displayed and then may deliver the generated touch event to an application organizing the execution screen 1200 including the button object 1210.

For another example, as illustrated in a second state 1203, text data may be mapped to an icon (e.g., a first icon 1231 or a second icon 1233) displayed on the screen 1200. For example, when first text data 1235 (e.g., “Message”) mapped to the first icon 1231 or second text data 1237 (e.g., “Internet”) mapped to the second icon 1233 is uttered by the user, the electronic device may perform the function of an icon corresponding to the uttered text data. For example, when the first text data 1235 is uttered, the electronic device may execute the function of the first icon 1231, that is, a message application; when the second text data 1237 is uttered, the electronic device may execute the function of the second icon 1233, that is, an Internet connection application.

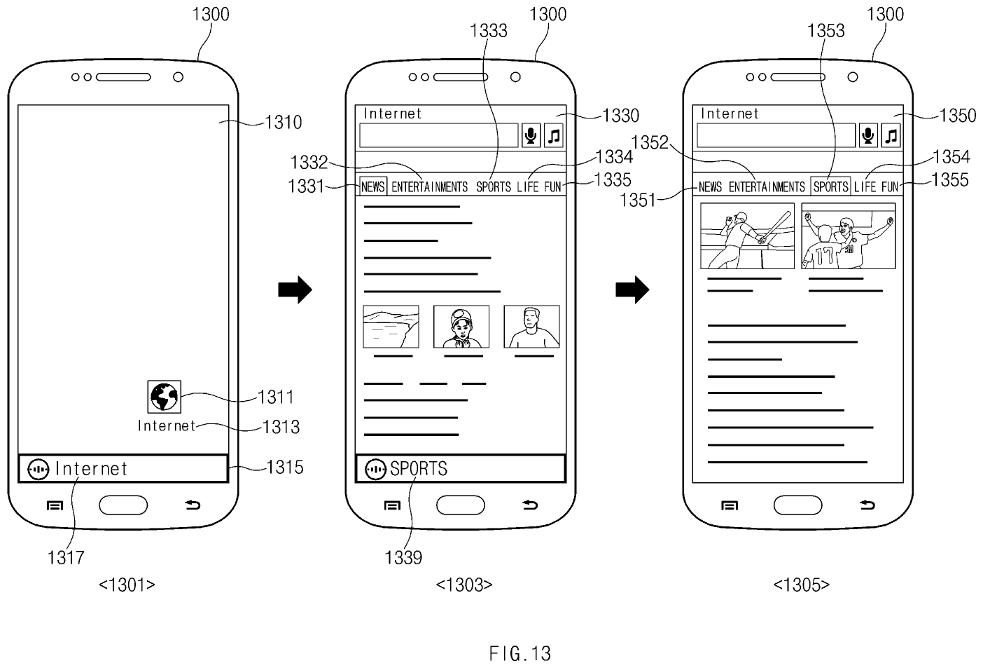

FIG. 13 is a view for describing function execution using screen configuration information, according to an embodiment of the disclosure.

Referring to FIG. 13, an electronic device 1300 (e.g., the electronic device 600) according to an embodiment may display at least a piece of content (e.g., an icon 1311) on a screen 1310. When receiving the voice uttered from a user via a microphone, the electronic device 1300 according to an embodiment may transmit voice data corresponding to the voice to the intelligence server 200. In this case, the intelligence server 200 according to an embodiment may convert the received voice data to text data and then may transmit the converted text data to the electronic device 1300.

When receiving the text data from the intelligence server 200, the electronic device 1300 according to an embodiment may determine whether the text data displayed on the screen 1310 is the same as the received text data; when the pieces of text data are the same as each other, the electronic device 1300 may perform the function corresponding to the text data.

According to an embodiment, as illustrated in a first state 1301, in a state where an icon 1311 is displayed on the first screen 1310 (e.g., a home screen), when first text data 1317 (e.g., “Internet”) received from the intelligence server 200 is the same as second text data 1313 (e.g., “Internet”) mapped to the icon 1311 displayed on the first screen 1310, the electronic device 1300 may perform the function of the icon 1311 as illustrated in a second state 1303. That is, the electronic device 1300 may execute an Internet connection application and then may output a first execution screen 1330 of the Internet connection application to a display.

According to an embodiment, as illustrated in a second state 1303, an electronic device 1300 may receive third text data 1339 (e.g., “sports”) from the intelligence server 200 based on the utterance of a user, in a state where an execution screen 1330 (e.g., the first execution screen of an Internet connection application) of an application is output. In this case, as illustrated in the home screen 1310 of the first state 1301, the electronic device 1300 may collect information about at least one text organized in the execution screen 1330 of an application. For example, in a second state 1303, the electronic device 1300 may determine that fourth text data 1331 (e.g., “news”), fifth text data 1332 (e.g., “entertainments”), sixth text data 1333 (e.g., “sports”), seventh text data 1334 (e.g., “life”), and eighth text data 1335 (e.g., “FUN”) are organized in the execution screen 1330 of an application. Also, the electronic device 1300 may determine whether there is text data the same as the third text data 1339 obtained from the intelligence server 200 in at least one text data organized in the execution screen 1330 of the application; when the same text data is present, the electronic device 1300 may perform the function corresponding to the same text data. In the illustrated drawings, as illustrated in a third state 1305, an electronic device 1300 may display the function corresponding to the sixth text data 1333, that is, a page corresponding to “sports” in an Internet search page, by determining that the third text data 1339 obtained from the intelligence server 200 is the same as the sixth text data 1333 organized in the execution screen 1330 of an application.

Moreover, even in illustrated in the third state 1305, the electronic device 1300 may receive the voice input of the user and may collect information (e.g., ninth text data 1351, tenth text data 1352, eleventh text data 1353, twentieth text data 1354, or thirteen text data 1355) about at least one text organized in an execution screen 1350 (e.g., the second execution screen (“sports” page) of an the Internet connection application) of the application.

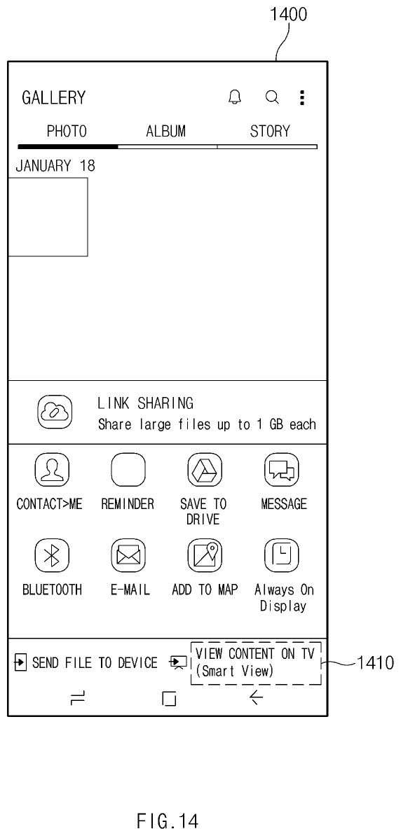

FIG. 14 is a view for describing function execution using a part of screen configuration information, according to an embodiment of the disclosure.

Referring to FIG. 14, an electronic device (e.g., the electronic device 600) may perform a function, using a part of screen configuration information including information about at least a piece of content displayed on a screen 1400. For example, when text data received from the intelligence server 200, that is, the text data converted based on the voice uttered by a user is the same as a part of text data displayed on a screen 1400, an electronic device may perform the function corresponding to the text data.

According to an embodiment, when the user does not accurately utter the text data displayed on the screen 1400, for example, when the text data displayed on the screen 1400 includes a special character such as a symbol, or the like, the electronic device may compare the pieces of text data other than the special character upon comparing the pieces of text data. For example, as illustrated, when a special character (e.g., “(”, and “)”) is included in the first text data 1410 (e.g., “view content on TV (Smart View)”) displayed on the screen 1400, the electronic device may compare only the remaining first text data other than the special character with second text data received from the intelligence server 200. Furthermore, the electronic device may also exclude a blank character (e.g., “ ”) from the first text data and may compare only the remaining first text data with the second text data.

According to an embodiment, the electronic device may compare only the part of the text data displayed on the screen 1400 with the text data received from the intelligence server 200. For example, as illustrated, when the first text data 1410 (e.g., “view content on TV (Smart View)”) displayed on the screen 1400 is the same as the second text data received from the intelligence server 200, the electronic device may perform the function corresponding to the first text data 1410. For example, when at least one of a first portion (e.g., “on TV”), a second portion (e.g., “content”), a third portion (e.g., “view”), and a fourth portion (e.g., “Smart view”) (other than the special character in the case of the fourth portion), which are separated by the blank character in the first text data 1410, is the same as the second text data received from the intelligence server 200, the electronic device may perform the function corresponding to the first text data 1410. For another example, even when a part of the text data included in the first portion, the second portion, the third portion, or the fourth portion is the same as the second text data, the electronic device may perform the function corresponding to the first text data 1410. For example, even when only the portion (e.g., “TV”) included in the first portion is the same as the second text data, the electronic device may perform the function corresponding to the first text data. In this case, the electronic device may determine whether pieces of text data displayed on the screen 1400 overlap with one another and then may perform the function as long as there is no text data overlapping with one another. For example, when the part (e.g., “TV”) included in the first portion of the first text data 1410 is included in other text data displayed on the screen 1400, the electronic device may not perform the function.

According to an embodiment, when the electronic device performs the function using screen configuration information, that is, when the electronic device receives the converted text data from the intelligence server 200 based on the utterance of the user, compares the received text data with text data displayed on the screen 1400, and performs the function corresponding to text data because at least parts of the pieces of text data are the same as each other, the electronic device may display a notification object for providing a notification that a function has been performed using the screen configuration information, on the screen 1400 The notification object may include at least one of a specified text (e.g., “execute a voice command”, or the like) and an image. In an embodiment, the electronic device may output the notification object on the partial region of the screen 1400 during a specified time and may automatically terminate the output when the specified time has elapsed. For example, the electronic device may display the notification object on the screen 1400 in the form of a toast pop up message.

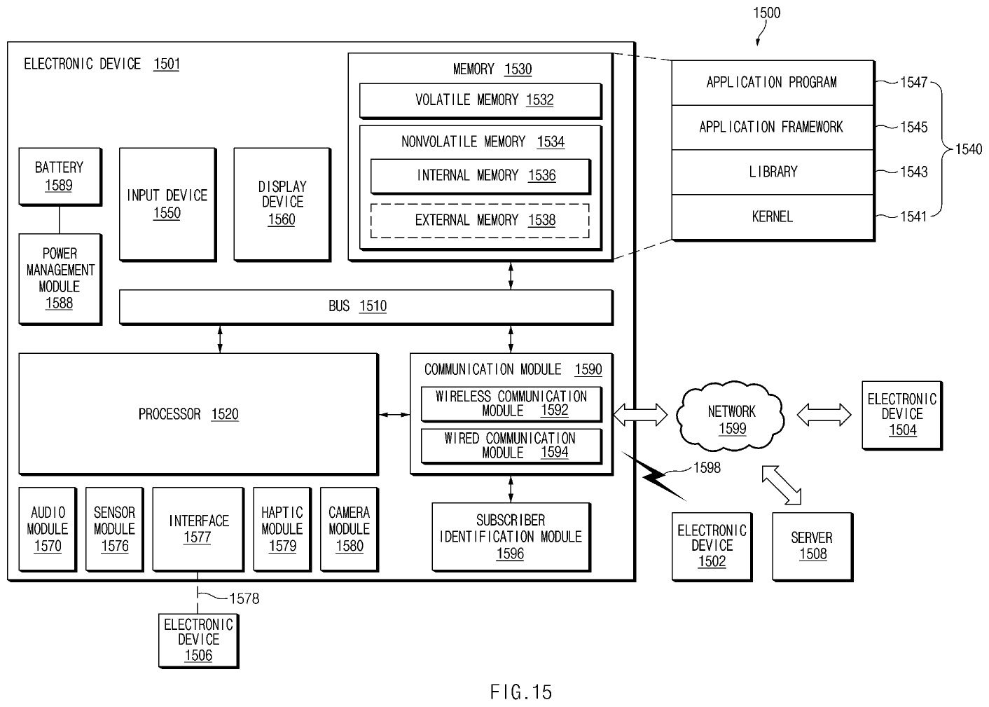

FIG. 15 illustrates a block diagram of an electronic device 1501 in a network environment 1500, according to various embodiments. An electronic device according to various embodiments of the disclosure may include various forms of devices. For example, the electronic device may include at least one of, for example, portable communication devices (e.g., smartphones), computer devices (e.g., personal digital assistants (PDAs), tablet personal computers (PCs), laptop PCs, desktop PCs, workstations, or servers), portable multimedia devices (e.g., electronic book readers or Motion Picture Experts Group (MPEG-1 or MPEG-2) Audio Layer 3 (MP3) players), portable medical devices (e.g., heartbeat measuring devices, blood glucose monitoring devices, blood pressure measuring devices, and body temperature measuring devices), cameras, or wearable devices. The wearable device may include at least one of an accessory type (e.g., watches, rings, bracelets, anklets, necklaces, glasses, contact lens, or head-mounted-devices (HMDs)), a fabric or garment-integrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disk (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, or electronic picture frames.

In another embodiment, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automated teller machines (ATMs), points of sales (POSs), measuring instruments (e.g., water meters, electricity meters, or gas meters), or internet of things (e.g., light bulbs, sprinkler devices, fire alarms, thermostats, or street lamps). The electronic device according to an embodiment of the disclosure may not be limited to the above-described devices, and may provide functions of a plurality of devices like smartphones which have measurement function of personal biometric information (e.g., heart rate or blood glucose). In the disclosure, the term “user” may refer to a person who uses an electronic device or may refer to a device (e.g., an artificial intelligence electronic device) that uses the electronic device.

Referring to FIG. 15, under the network environment 1500, the electronic device 1501 (e.g., the electronic device 600 of FIG. 1) may communicate with an electronic device 1502 through local wireless communication 1598 or may communication with an electronic device 1504 or a server 1508 through a network 1599. According to an embodiment, the electronic device 1501 may communicate with the electronic device 1504 through the server 1508.

According to an embodiment, the electronic device 1501 may include a bus 1510, a processor 1520 (e.g., the processor 650), a memory 1530 (e.g., the memory 670), an input device 1550 (e.g., the microphone 610 or a mouse), a display device 1560 (e.g., the display device 630), an audio module 1570, a sensor module 1576, an interface 1577, a haptic module 1579, a camera module 1580, a power management module 1588, a battery 1589, a communication module 1590 (e.g. the communication circuit 690), and a subscriber identification module 1596. According to an embodiment, the electronic device 1501 may not include at least one (e.g., the display device 1560 or the camera module 1580) of the above-described components or may further include other component(s).

The bus 1510 may interconnect the above-described components 1520 to 1590 and may include a circuit for conveying signals (e.g., a control message or data) between the above-described components.

The processor 1520 may include one or more of a central processing unit (CPU), an application processor (AP), a graphic processing unit (GPU), an image signal processor (ISP) of a camera or a communication processor (CP). According to an embodiment, the processor 1520 may be implemented with a system on chip (SoC) or a system in package (SiP). For example, the processor 1520 may drive an operating system (OS) or an application program to control at least one of another component (e.g., hardware or software component) of the electronic device 1501 connected to the processor 1520 and may process and compute various data. The processor 1520 may load a command or data, which is received from at least one of other components (e.g., the communication module 1590), into a volatile memory 1532 to process the command or data and may store the result data into a nonvolatile memory 1534.

The memory 1530 may include, for example, the volatile memory 1532 or the nonvolatile memory 1534. The volatile memory 1532 may include, for example, a random access memory (RAM) (e.g., a dynamic RAM (DRAM), a static RAM (SRAM), or a synchronous DRAM (SDRAM)). The nonvolatile memory 1534 may include, for example, a programmable read-only memory (PROM), an one time PROM (OTPROM), an erasable PROM (EPROM), an electrically EPROM (EEPROM), a mask ROM, a flash ROM, a flash memory, a hard disk drive (HDD), or a solid-state drive (SSD). In addition, the nonvolatile memory 1534 may be configured in the form of an internal memory 1536 or the form of an external memory 1538 which is available through connection only if necessary, according to the connection with the electronic device 1501. The external memory 1538 may further include a flash drive such as compact flash (CF), secure digital (SD), micro secure digital (Micro-SD), mini secure digital (Mini-SD), extreme digital (xD), a multimedia card (MMC), or a memory stick. The external memory 1538 may be operatively or physically connected with the electronic device 1501 in a wired manner (e.g., a cable or a universal serial bus (USB)) or a wireless (e.g., Bluetooth) manner.

For example, the memory 1530 may store, for example, at least one different software component, such as a command or data associated with the program 1540, of the electronic device 1501. The program 1540 may include, for example, a kernel 1541, a library 1543, an application framework 1545 or an application program (interchangeably, “application”) 1547.

The input device 1550 may include a microphone, a mouse, or a keyboard. According to an embodiment, the keyboard may include a keyboard physically connected or a virtual keyboard displayed through the display device 1560.

The display device 1560 may include a display, a hologram device or a projector, and a control circuit to control a relevant device. The display may include, for example, a liquid crystal display (LCD), a light emitting diode (LED) display, an organic LED (OLED) display, a microelectromechanical systems (MEMS) display, or an electronic paper display. According to an embodiment, the display may be flexibly, transparently, or wearably implemented. The display may include a touch circuitry, which is able to detect a user's input such as a gesture input, a proximity input, or a hovering input or a pressure sensor (interchangeably, a force sensor) which is able to measure the intensity of the pressure by the touch. The touch circuit or the pressure sensor may be implemented integrally with the display or may be implemented with at least one sensor separately from the display. The hologram device may show a stereoscopic image in a space using interference of light. The projector may project light onto a screen to display an image. The screen may be located inside or outside the electronic device 1501.

The audio module 1570 may convert, for example, from a sound into an electrical signal or from an electrical signal into the sound. According to an embodiment, the audio module 1570 may acquire sound through the input device 1550 (e.g., a microphone) or may output sound through an output device (not illustrated) (e.g., a speaker or a receiver) included in the electronic device 1501, an external electronic device (e.g., the electronic device 1502 (e.g., a wireless speaker or a wireless headphone)) or an electronic device 1506 (e.g., a wired speaker or a wired headphone) connected with the electronic device 1501

The sensor module 1576 may measure or detect, for example, an internal operating state (e.g., power or temperature) of the electronic device 1501 or an external environment state (e.g., an altitude, a humidity, or brightness) to generate an electrical signal or a data value corresponding to the information of the measured state or the detected state. The sensor module 1576 may include, for example, at least one of a gesture sensor, a gyro sensor, a barometric pressure sensor, a magnetic sensor, an acceleration sensor, a grip sensor, a proximity sensor, a color sensor (e.g., a red, green, blue (RGB) sensor), an infrared sensor, a biometric sensor (e.g., an iris sensor, a fingerprint senor, a heartbeat rate monitoring (FIRM) sensor, an e-nose sensor, an electromyography (EMG) sensor, an electroencephalogram (EEG) sensor, an electrocardiogram (ECG) sensor), a temperature sensor, a humidity sensor, an illuminance sensor, or an UV sensor. The sensor module 1576 may further include a control circuit for controlling at least one or more sensors included therein. According to an embodiment, the electronic device 1501 may control the sensor module 1576 by using the processor 1520 or a processor (e.g., a sensor hub) separate from the processor 1520. In the case that the separate processor (e.g., a sensor hub) is used, while the processor 1520 is in a sleep state, the separate processor may operate without awakening the processor 1520 to control at least a portion of the operation or the state of the sensor module 1576.

According to an embodiment, the interface 1577 may include a high definition multimedia interface (HDMI), a universal serial bus (USB), an optical interface, a recommended standard 232 (RS-232), a D-subminiature (D-sub), a mobile high-definition link (MHL) interface, a SD card/MMC (multi-media card) interface, or an audio interface. A connector 1578 may physically connect the electronic device 1501 and the electronic device 1506. According to an embodiment, the connector 1578 may include, for example, an USB connector, an SD card/MMC connector, or an audio connector (e.g., a headphone connector).

The haptic module 1579 may convert an electrical signal into mechanical stimulation (e.g., vibration or motion) or into electrical stimulation. For example, the haptic module 1579 may apply tactile or kinesthetic stimulation to a user. The haptic module 1579 may include, for example, a motor, a piezoelectric element, or an electric stimulator.

The camera module 1580 may capture, for example, a still image and a moving picture. According to an embodiment, the camera module 1580 may include at least one lens (e.g., a wide-angle lens and a telephoto lens, or a front lens and a rear lens), an image sensor, an image signal processor, or a flash (e.g., a light emitting diode or a xenon lamp).

The power management module 1588, which is to manage the power of the electronic device 1501, may constitute at least a portion of a power management integrated circuit (PMIC).

The battery 1589 may include a primary cell, a secondary cell, or a fuel cell and may be recharged by an external power source to supply power at least one component of the electronic device 1501.

The communication module 1590 may establish a communication channel between the electronic device 1501 and an external device (e.g., the first external electronic device 1502, the second external electronic device 1504, or the server 1508). The communication module 1590 may support wired communication or wireless communication through the established communication channel. According to an embodiment, the communication module 1590 may include a wireless communication module 1592 or a wired communication module 1594. The communication module 1590 may communicate with the external device through a first network 1598 (e.g. a wireless local area network such as Bluetooth or infrared data association (IrDA)) or a second network 1599 (e.g., a wireless wide area network such as a cellular network) through a relevant module among the wireless communication module 1592 or the wired communication module 1594.

The wireless communication module 1592 may support, for example, cellular communication, local wireless communication, and global navigation satellite system (GNSS) communication. The cellular communication may include, for example, long-term evolution (LTE), LTE Advance (LTE-A), code division multiple access (CDMA), wideband CDMA (WCDMA), universal mobile telecommunications system (UMTS), Wireless Broadband (WiBro), or Global System for Mobile Communications (GSM). The local wireless communication may include wireless fidelity (Wi-Fi), Wi-Fi Direct, light fidelity (Li-Fi), Bluetooth, Bluetooth low energy (BLE), ZigBee, near field communication (NFC), magnetic secure transmission (MST), radio frequency (RF), or a body area network (BAN). The GNSS may include at least one of a Global Positioning System (GPS), a Global Navigation Satellite System (Glonass), Beidou Navigation Satellite System (Beidou), the European global satellite-based navigation system (Galileo), or the like. In the disclosure, “GPS” and “GNSS” may be interchangeably used.

According to an embodiment, when the wireless communication module 1592 supports cellar communication, the wireless communication module 1592 may, for example, identify or authenticate the electronic device 1501 within a communication network using the subscriber identification module (e.g., a SIM card) 1596. According to an embodiment, the wireless communication module 1592 may include a communication processor (CP) separate from the processor 1520 (e.g., an application processor (AP)). In this case, the communication processor may perform at least a portion of functions associated with at least one of components 1510 to 1596 of the electronic device 1501 in substitute for the processor 1520 when the processor 1520 is in an inactive (sleep) state, and together with the processor 1520 when the processor 1520 is in an active state. According to an embodiment, the wireless communication module 1592 may include a plurality of communication modules, each supporting only a relevant communication scheme among cellular communication, local wireless communication, or a GNSS communication.

The wired communication module 1594 may include, for example, a local area network (LAN) service, a power line communication, or a plain old telephone service (POTS).

For example, the first network 1598 may employ, for example, Wi-Fi direct or Bluetooth for transmitting or receiving commands or data through wireless direct connection between the electronic device 1501 and the first external electronic device 1502. The second network 1599 may include a telecommunication network (e.g., a computer network such as a LAN or a WAN, the Internet or a telephone network) for transmitting or receiving commands or data between the electronic device 1501 and the second electronic device 1504.

According to various embodiments, the commands or the data may be transmitted or received between the electronic device 1501 and the second external electronic device 1504 through the server 1508 connected with the second network 1599. Each of the first and second external electronic devices 1502 and 1504 may be a device of which the type is different from or the same as that of the electronic device 1501. According to various embodiments, all or a part of operations that the electronic device 1501 will perform may be executed by another or a plurality of electronic devices (e.g., the electronic devices 1502 and 1504 or the server 1508). According to an embodiment, in the case that the electronic device 1501 executes any function or service automatically or in response to a request, the electronic device 1501 may not perform the function or the service internally, but may alternatively or additionally transmit requests for at least a part of a function associated with the electronic device 1501 to any other device (e.g., the electronic device 1502 or 1504 or the server 1508). The other electronic device (e.g., the electronic device 1502 or 1504 or the server 1508) may execute the requested function or additional function and may transmit the execution result to the electronic device 1501. The electronic device 1501 may provide the requested function or service using the received result or may additionally process the received result to provide the requested function or service. To this end, for example, cloud computing, distributed computing, or client-server computing may be used.

Various embodiments of the disclosure and terms used herein are not intended to limit the technologies described in the disclosure to specific embodiments, and it should be understood that the embodiments and the terms include modification, equivalent, and/or alternative on the corresponding embodiments described herein. With regard to description of drawings, similar components may be marked by similar reference numerals. The terms of a singular form may include plural forms unless otherwise specified. In the disclosure disclosed herein, the expressions “A or B”, “at least one of A and/or B”, “A, B, or C”, or “at least one of A, B, and/or C”, and the like used herein may include any and all combinations of one or more of the associated listed items. Expressions such as “first,” or “second,” and the like, may express their components regardless of their priority or importance and may be used to distinguish one component from another component but is not limited to these components. When an (e.g., first) component is referred to as being “(operatively or communicatively) coupled with/to” or “connected to” another (e.g., second) component, it may be directly coupled with/to or connected to the other component or an intervening component (e.g., a third component) may be present.

According to the situation, the expression “adapted to or configured to” used herein may be interchangeably used as, for example, the expression “suitable for”, “having the capacity to”, “changed to”, “made to”, “capable of” or “designed to” in hardware or software. The expression “a device configured to” may mean that the device is “capable of” operating together with another device or other parts. For example, a “processor configured to (or set to) perform A, B, and C” may mean a dedicated processor (e.g., an embedded processor) for performing corresponding operations or a generic-purpose processor (e.g., a central processing unit (CPU) or an application processor (AP)) which performs corresponding operations by executing one or more software programs which are stored in a memory device (e.g., the memory 1530).

The term “module” used herein may include a unit, which is implemented with hardware, software, or firmware, and may be interchangeably used with the terms “logic”, “logical block”, “part”, “circuit”, or the like. The “module” may be a minimum unit of an integrated part or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media (e.g., the memory 1530) in the form of a program module. The instruction, when executed by a processor (e.g., the processor 1520), may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The one or more instructions may contain a code made by a compiler or a code executable by an interpreter.

Each component (e.g., a module or a program module) according to various embodiments may be composed of single entity or a plurality of entities, a part of the above-described sub-components may be omitted, or other sub-components may be further included. Alternatively or additionally, after being integrated in one entity, some components (e.g., a module or a program module) may identically or similarly perform the function executed by each corresponding component before integration. According to various embodiments, operations executed by modules, program modules, or other components may be executed by a successive method, a parallel method, a repeated method, or a heuristic method, or at least one part of operations may be executed in different sequences or omitted. Alternatively, other operations may be added.

1. An electronic device comprising:
a microphone;
a communication circuit;
a display;
a memory configured to store at least one application; and
a processor electrically connected to the microphone, the communication circuit, the display, and the memory,
wherein the processor is configured to:
obtain voice data corresponding to a voice of a user received via the microphone and obtain first information about at least one text displayed on a screen of the display;
transmit the voice data to an external electronic device via the communication circuit;
receive first text data converted based on the voice data from the external electronic device via the communication circuit;
determine whether second text data the same as the first text data is present in the first information, and execute a first function corresponding to the second text data using the first information when the second text data is present;
receive second information configured to execute a second function of the at least one application, from the external electronic device via the communication circuit; and
execute the second function when the first function is not executed and restrict processing of the second information when the first function is executed.

2. The electronic device of claim 1, wherein the first information includes at least one of identification information of the at least one text, coordinate information at which the at least one text is displayed, and text data corresponding to the at least one text.

3. The electronic device of claim 2, wherein the processor is configured to:
determine coordinates at which a text corresponding to the second text data is displayed on the screen, based on the coordinate information; and
generate a signal associated with occurrence of a touch input at the coordinates.

4. The electronic device of claim 3, wherein the processor is configured to:
transmit the signal to an application organizing the screen, on which the text corresponding to the second text data is displayed, from among the at least one application.

5. The electronic device of claim 3, wherein the processor is configured to:
transmit the signal to an application, which is being executed in foreground, from among the at least one application.

6. The electronic device of claim 1, wherein the processor is configured to:
store history information about execution of the first function, in the memory.

7. The electronic device of claim 6, wherein the processor is configured to:
determine whether the first function is executed, based on the history information.

8. The electronic device of claim 1, wherein the second information includes at least one of information about an action for executing the second function, information about a parameter necessary to execute the action, and order information of the action.

9. An electronic device comprising:
a microphone;
a communication circuit;
a display;
a memory configured to store at least one application; and
a processor electrically connected to the microphone, the communication circuit, the display, and the memory,
wherein the processor is configured to:
obtain voice data corresponding to a voice of a user received via the microphone and obtain first information about at least one text displayed on a screen of the display;
transmit the voice data to an external electronic device via the communication circuit;
receive first text data converted based on the voice data from the external electronic device via the communication circuit;
determine whether second text data the same as the first text data is present in the first information;
when the second text data is present, execute a first function corresponding to the second text data, using the first information; and
when the second text data is not present, enter a waiting state for receiving second information configured to execute a second function of the at least one application.

10. The electronic device of claim 9, wherein the processor is configured to:
when the first function is executed, transmit information for providing a notification that the first function has been executed, to the external electronic device via the communication circuit.

11. The electronic device of claim 9, wherein the first information includes at least one of identification information of the at least one text, coordinate information at which the at least one text is displayed, and text data corresponding to the at least one text.

12. The electronic device of claim 11, wherein the processor is configured to:
determine coordinates at which a text corresponding to the second text data is displayed on the screen, based on the coordinate information; and
generate a signal associated with occurrence of a touch input at the coordinates.

13. The electronic device of claim 9, wherein the second information includes at least one of information about an action for executing the second function, information about a parameter necessary to execute the action, and order information of the action.

14. The electronic device of claim 9, wherein the processor is configured to:
when receiving the second information from the external electronic device via the communication circuit in the waiting state, execute the second function based on the second information.

15. A voice data processing method of an electronic device, the method comprising:
obtaining voice data corresponding to a voice of a user received via a microphone;
obtaining first information about at least one text displayed on a screen of a display;
transmitting the voice data to an external electronic device via a communication circuit;
receiving first text data converted based on the voice data, from the external electronic device via the communication circuit;
determining whether second text data the same as the first text data is present in the first information;
when the second text data is present, executing a first function corresponding to the second text data, using the first information;
receiving second information configured to execute a second function of at least one application stored in a memory, from the external electronic device via the communication circuit;
determining whether the first function is executed;
when the first function is not executed, executing the second function; and
when the first function is executed, restricting processing of the second information.
